(19) United States
(12) Patent Application Publication
(10) Pub. No.: US 2010/0011038 A1
(43) Pub. Date: Jan. 14, 2010

(54) DISTRIBUTED STORAGE MANAGING APPARATUS, DISTRIBUTED STORAGE MANAGING METHOD, AND COMPUTER PRODUCT

(75) Inventor: Yuichi Tsuchimoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/417,467

(22) Filed: Apr. 2, 2009

(30) Foreign Application Priority Data
Jul. 14, 2008 (JP) 2008-183053

(51) Int. Cl. G06F 12/00; G06F 12/02

(52) U.S. Cl. 707/205; 711/112; 707/E17.01

(57) ABSTRACT

A computer-readable recording medium stores therein a distributed storage managing program that causes a computer to execute obtaining a quantity M, the quantity M being a quantity of classes to which files are to be allocated; allocating, according to a predetermined algorithm, the files to the classes of the quantity M obtained at the obtaining; and allocating, by class and to storage apparatuses of a second quantity that is different from a current quantity of storage apparatuses, the files allocated to the classes of the quantity M at the allocating of the files to the classes, when a quantity of storage apparatuses used to store the files is changed from the current quantity to the second quantity.

### CROSS REFERENCE TO RELATED APPLICATIONS

This application is based upon and claims the benefit of priority of the prior Japanese Patent Application No. 2008-183053, filed on Jul. 14, 2008, the entire contents of which are incorporated herein by reference.

### FIELD

The embodiments discussed herein are related to distributed storage management and dynamic varying of the quantity of disk apparatuses employed.

### BACKGROUND

For a distributed storage system constituted of a multiple disk apparatuses, the number of files retained in each of the disk apparatuses are demanded to be sufficiently equivalent to maximize the performance of the disk apparatuses. Because the storage capacity demanded may vary significantly, the quantity of disk apparatuses is demanded to be dynamically variable.

To satisfy these demands, the moving of the files (relocation) is needed when the quantity of disk apparatuses is changed. Conventionally, manager-based and algorithm-based techniques are known as approaches of distributing a large amount of data to multiple storage apparatuses and managing the data (see, e.g., “‘Mixi’ CTO Shows: ‘How Mixi Has Dealt with Increasing Traffic?’”, [online], Mar. 30, 2006, Nikkei Software, [Searched on Oct. 1, 2007], the Internet <URL: http://itpro.nikkeibp.co.jp/article/NEWS/20060330/233820/>.

According to the manager-based technique, a computer apparatus serving as a manager manages, for each file, a corresponding disk apparatus. Thereby, disk apparatuses can be flexibly allocated to a group of files, the number of files in each of the disk apparatuses can equalized, and file relocation can be minimized when the quantity of disk apparatuses is changed.

According to the algorithm-based technique, each file is assigned to a corresponding disk apparatus based on a hash value calculated from keywords such as a file name. Thereby, mapping for each file is executable in parallel when files are added, referenced, changed, deleted, etc.

More specifically, for example, a sufficiently large integer is generated from the file names and mapping is executed using the remainder obtained by dividing the integer by the quantity of disk apparatuses. Thereby, when the quantity of the disk apparatuses is changed from “a” to “b” or from “b” to “a” (where a<b), the number of files requiring relocation is (b−N)/b assuming that the greatest common divisor of “a” and “b” is “N”.

However, according to the manager-based technique above, the manager executes the management of each file in an integrated manner and, therefore, all inquiries concerning additions, references, changes, and deletions concentrate on the manager. Consequently, a problem arises in that bottle necks occur due to communication traffic and exclusive control.

According to the algorithm-based technique above, to sufficiently equalize the number of file per disk apparatus, an approach such as that of dividing a hash function that generates a random value by the quantity of disk apparatuses is taken. Therefore, a problem has arisen in that file relocation associated with an increase or a decrease of the disk apparatuses cannot be minimized.

More specifically, disk apparatuses to which files are relocated change significantly depending on the quantity of all the disk apparatuses at the time of the relocation; thus, a problem arises in that a large amount of file relocation occurs when the quantity of the disk apparatuses is changed.

### SUMMARY

According to an aspect of an embodiment, a computer-readable recording medium stores therein a distributed storage managing program that causes a computer to execute obtaining a quantity M, the quantity M being a quantity of classes to which files are to be allocated; allocating, according to a predetermined algorithm, the files to the classes of the quantity M obtained at the obtaining; and allocating, by class and to storage apparatuses of a second quantity that is different from a current quantity of storage apparatuses, the files allocated to the classes of the quantity M at the allocating of the files to the classes, when a quantity of storage apparatuses used to store the files is changed from the current quantity to the second quantity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a configuration of a storage system according to an embodiment;

FIG. 2 is an explanatory diagram of a hardware configuration of computer apparatuses according to the embodiment;

FIG. 3 is a functional diagram of a distributed storage managing apparatus according to a first embodiment;

FIG. 4 is a diagram of an exemplary allocation table;

FIG. 5 is a flowchart of distributed storage processing performed by the distributed storage managing apparatus according to the first embodiment;

FIG. 6 is a schematic of an overview of distributed storage processing according to a first example of the first embodiment;

FIG. 7 is a flowchart of the distributed storage processing according to the first example of the first embodiment;

FIG. 8 is a schematic of an overview of distributed storage processing in a second example of the first embodiment;

FIG. 9 is a flowchart of the storage processing in the second example of the first embodiment;

FIG. 10 is a schematic of an overview of the exemplary operation of servers;

FIG. 11 is a flowchart of writing processing by the servers;

FIG. 12 is a diagram another exemplary allocation table;

FIG. 13 is a schematic of an overview of distributed storage processing in a fourth example of a second embodiment;

FIG. 14 is a flowchart detailing the processing of a pre-operation preparation process;

FIG. 15 is a flowchart of distributed storage processing for an increase;

FIG. 16 is a schematic of distributed storage processing in a fifth example of the second embodiment;

FIG. 17 is a flowchart of distributed storage processing for a reduction;

FIG. 18 is a schematic of an overview of distributed storage processing in a sixth example of a third embodiment;

FIG. 19 is another flowchart of the pre-operation preparation process; and

FIG. 20 is another flowchart of the distributed storage processing for an increase.

### DESCRIPTION OF EMBODIMENT(S)

Preferred embodiments of the present invention will be explained with reference to the accompanying drawings.

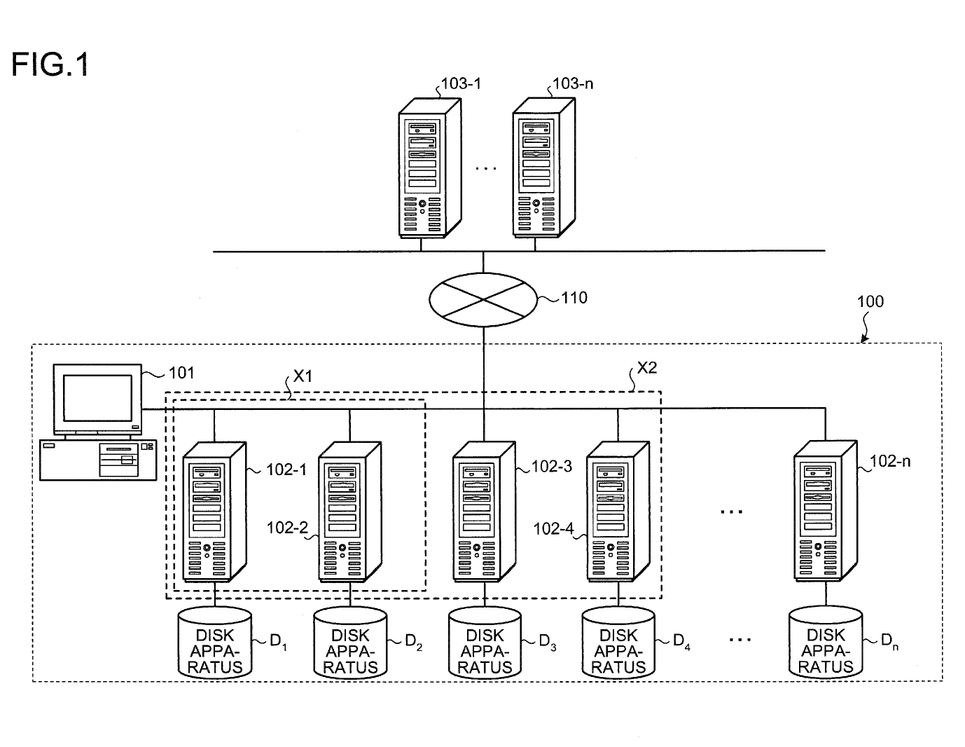

FIG. 1 is a diagram of a configuration of a storage system according to an embodiment. As depicted in FIG. 1, a storage system 100 includes a distributed storage managing apparatus 101 and multiple servers 102-1 to 102-n that are mutually communicable and connected through a network 110 such as the Internet, a local area network (LAN), or a wide area network (WAN).

The storage system 100 provides a storage service to external apparatuses 103-1 to 103-n such as web servers. The storage service is a service of retaining an arbitrary group of files in disk apparatuses D₁ to Dₙ of the servers 102-1 to 102-n and managing the files. “D₁ to Dₙ” are disk numbers given to the disk apparatuses.

The storage system 100 can dynamically vary, according to the storage capacity demanded and the quantity of accesses, the quantity of the disk apparatuses D₁ to Dₙ to retain the files. For example, when the storage capacity demanded is small, the storage service is operated by two of the disk apparatuses D₁ and D₂ (X1 in FIG. 1).

Thereafter, for example, when the storage capacity demanded increases, the quantity of disk apparatuses D₁ to Dₙ is changed from two (the disk apparatuses D₁ and D₂) to four (disk apparatuses D₁ to D₄) (X2 in FIG. 1). In this case, to distribute the load on the servers 102-1 to 102-n, the files are evenly distributed to the disk apparatuses D₁ to D₄ by relocating data stored in the disk apparatuses D₁ to D₂.

The distributed storage managing apparatus 101 is a computer apparatus that manages the relocation of the files when the quantity of disk apparatuses D₁ to Dₙ is changed. The servers 102-1 to 102-n respectively include the disk apparatuses D₁ to Dₙ and are computer apparatuses that respectively control reading and writing of the files with respect to the disk apparatuses D₁ to Dₙ.

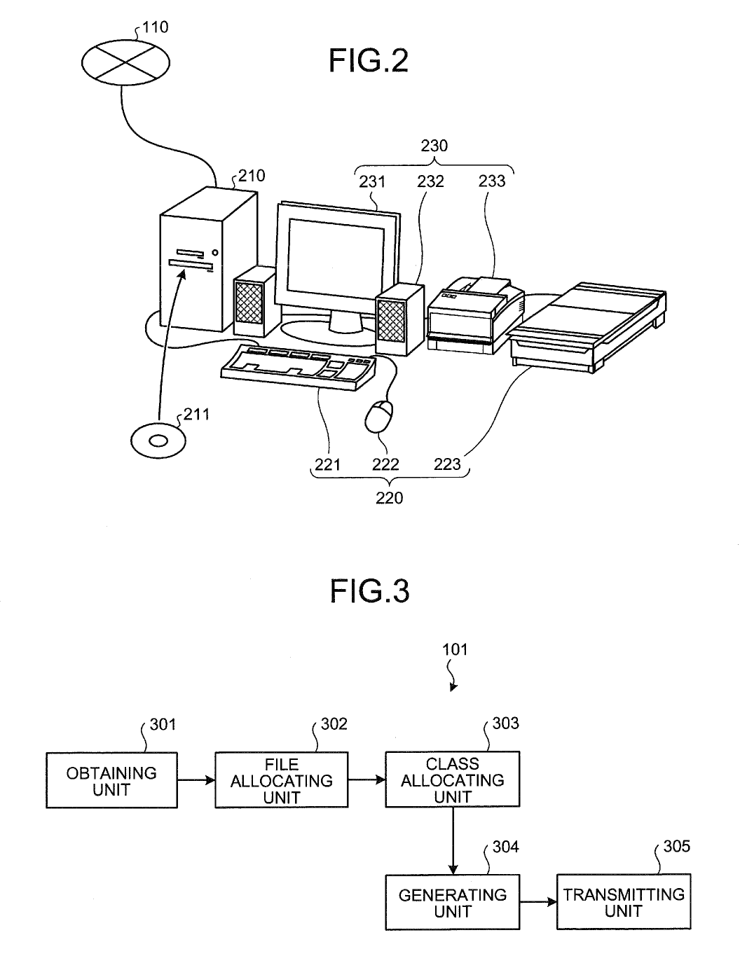

Hardware configurations of the distributed storage managing apparatus 101, the servers 102-1 to 102-n, and the external apparatuses 103-1 to 103-n (computer apparatuses) depicted in FIG. 1 will be described. FIG. 2 is an explanatory diagram of a hardware configuration of the computer apparatuses according to the embodiment.

As depicted in FIG. 2, the computer apparatus includes a computer main body 210, an input apparatus 220, and an output apparatus 230, and is connectable to the network 110 such as a LAN, a WAN, or the Internet through a router or a modem not depicted.

The computer main body 210 includes a central processing unit (CPU), a memory, and an interface. The CPU controls the entire computer apparatus. The memory includes a read-only memory (ROM), a random access memory (RAM), a hard drive (HD), an optical disk 211, and a flash memory. The memory is used as a work area of the CPU.

The memory stores various programs, which are loaded according to an instruction from the CPU. The reading and writing of data with respect to the HD and the optical disk 211 are controlled by a disk drive. Further, the optical disk 211 and the flash memory are detachable from the computer main body 210. The interface controls input from input device 220, output to the output device 230, and transmission/reception to and from the network 110.

The input device 220 includes a keyboard 221, a mouse 222, and a scanner 223. The keyboard 221 includes keys to input text, numerals, and various instructions. Further, the input device 220 can be a touch panel type device. The mouse 222 moves a cursor, determines an area, moves a window, or changes the dimensions for the window. The scanner 223 optically scans an image. The scanned image is imported as image data and stored in the memory of the computer main body 210. The scanner 223 may have an optical character recognition (OCR) function.

Further, the output device 230 includes a display 231, a speaker 232, and a printer 233. The display 231 displays a cursor, icons, toolboxes, and data such as documents, images, and function information. The speaker 232 outputs sound such as a sound effect, a read-out voice, and the like. The printer 233 outputs image date and document data.

FIG. 3 is a functional diagram of the distributed storage managing apparatus according to a first embodiment. As depicted in FIG. 3, the distributed storage managing apparatus 101 includes an obtaining unit 301, a file allocating unit 302, a class allocating unit 303, a generating unit 304, and a transmitting unit 305.

Functions that constitute a control unit (the obtaining unit 301 to the transmitting unit 305) are realized by causing the CPU to execute a relevant program stored in the memory. Data output as a result each of the functions is retained in the memory. The functions at connection destinations indicated at arrowheads in FIG. 3 are implemented by reading from the memory, data output from a connection origin, and by causing the CPU to execute a relevant program.

The obtaining unit 301 has a function of obtaining the quantity of classes “M” to which an arbitrary group of files is to be allocated. Storage apparatuses may be storage media such as an HD, the optical disk 211, flash memories, etc. (for example, the disk apparatuses D₁ to Dₙ) or may be computer apparatuses each including a storage medium (for example, the servers 102-1 to 102-n depicted in FIG. 1).

In this case, as the quantity of classes M, a common multiple “M” of the quantities of storage apparatuses to be re-organized is obtained. The “quantities of storage apparatuses to be re-organized” refers to a set of quantities, each of the quantities being a quantity of storage apparatuses {m₁, m₂ . . . , mₖ} (k: a natural number) that can be dynamically re-organized according to the storage capacity demanded, etc. An exemplary operation may be such that the quantity of storage apparatuses is increased when the storage capacity demanded is increased and the quantity of storage apparatuses is decreased when the storage capacity demanded is decreased.

The quantities of storage apparatuses to be re-organized are arbitrarily set in advance by a user (the manager of the storage system 100) operation of the input apparatus 220 such as the keyboard 221 or the mouse 222 depicted in FIG. 2. For example, it is assumed that {2, 4, 6} are set as the quantities. In this case, the obtaining unit 301, for example, calculates common multiples of {2, 4, 6} and obtains any one of the common multiples thereof “12, 24, 36, . . . ” as the common multiple M.

The least common multiple of the common multiples may be obtained as the common multiple M. The common multiple M may be obtained by direct input to the distributed storage managing apparatus 101 by a user operation of the input apparatus 220 such as the keyboard 221 or the mouse 222 depicted in FIG. 2.

The file allocating unit 302 has a function of allocating, according to a predetermined algorithm, an arbitrary group of files to classes equivalent in quantity to the common multiple M obtained by the obtaining unit 301. Here, the files may be, for example, files stored in the storage apparatuses currently in-use or may include files to be newly added (files not allocated to any of the storage apparatuses).

More specifically, for example, the file allocating unit 302 defines classes equivalent in quantity to the common multiple M and evenly groups the files into the classes using a predetermined algorithm. The predetermined algorithm is a function to evenly distribute the files to the classes equivalent in quantity to the common multiple M {C₁, C₂, . . . , C_{M}}.

The algorithm may be arbitrarily set by the user. More specifically, for example, one sufficiently even hash function h( ) that determines one integer from a character string expressing the file name of each file may be determined and the files may be classified into M classes by congruent (mod M) using the common multiple M as the modulus.

More specifically, for example, “SHA1 (Secure Hash Algorithm 1)” that is one hash function may be used. In this case, a function C( ) that evenly distributes the files to M classes {C₁, C₂ . . . , C_{M}} is determined as “C (a file name)=SHA1 (a file name) mod M”. Because “SHA1” is a known technique, the description thereof is omitted.

The class allocating unit 303 has a function of allocating, by each class, the files that are allocated to the classes of the quantity of the classes M by the file allocating unit 302 to an arbitrary quantity of storage apparatuses. The files are allocated by class using a predetermined algorithm such that the quantity of classes allocated to each storage apparatus is equivalent.

Here, it is assumed that “a” is provided as the quantity of storage apparatuses in an initial state. In this case, the class allocating unit 303 allocates to each storage apparatus, classes of a quantity M/a obtained by dividing the common multiple M by the quantity of storage apparatuses “a”. The quantity of storage apparatuses in the initial state may be directly input to the distributed storage managing apparatus 101 by a user operation of the input apparatus 220 depicted in FIG. 2, or may be set in advance when the storage system 100 is designed.

When the quantity of storage apparatus that are under use and storing files therein is changed from the current quantity (for example, the quantity in the initial state) to another quantity, the class allocating unit 303 has a function of allocating to storage apparatuses of the other quantity and by class, the files allocated to the M classes by the file allocating unit 302.

More specifically, for example, when the quantity of storage apparatuses is changed from the current quantity m₁ to another quantity m₂ among the quantities of storage apparatuses to be re-organized {m₁, m₂ . . . , mₖ}, allocation of the files, by class, to m₂ storage apparatuses is sufficiently equivalent. In this case, when all the files are stored in m₁ storage apparatuses before the change, allocation is executed with reference to an allocation table indicating corresponding relations between the classes and the m₂ storage apparatuses before the change.

When new files to be added are included among the files, the file allocating unit 302 may again allocate the files, including the new files, to the classes equivalent in quantity to the common multiple M and, thereafter, the class allocating unit 303 may allocate to storage apparatuses of another quantity, by class, the files allocated to the M classes.

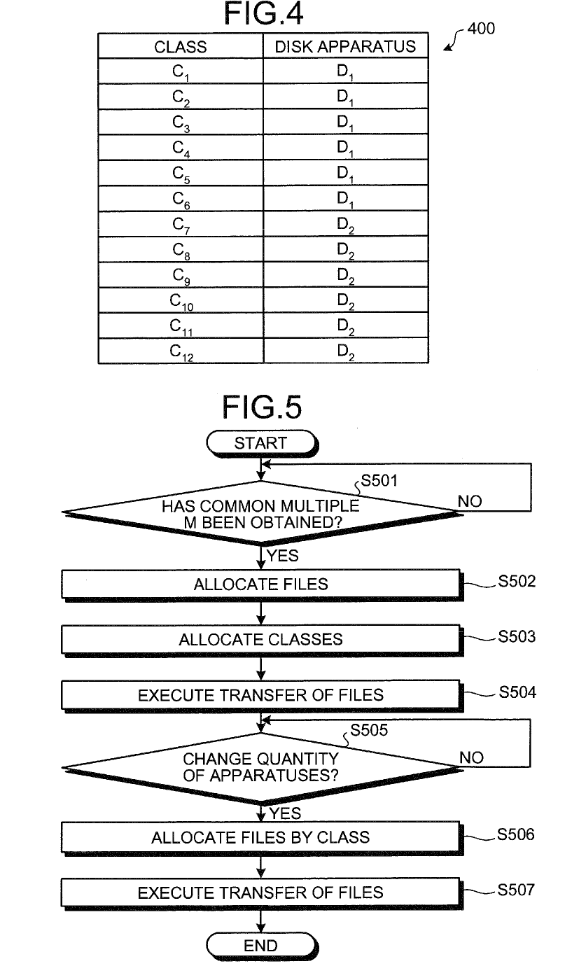

In this case, the allocation table depicts the result of the allocation executed by the class allocating unit 303 (see FIG. 4 described hereinafter). From the allocation table, the storage apparatuses to which the classes are allocated can be recognized. Described in detail hereinafter, when the allocating process by the class allocating unit 303 is completed, a transfer process for the files is executed using an arbitrary approach and the files are stored by class in the storage apparatuses to which the files have been allocated.

Determination of whether the quantity of storage apparatuses is to be changed, for example, may be determined automatically based on the storage capacity demanded. More specifically, when the storage capacity demanded is equal to or greater than a predetermined threshold for the current quantity of storage apparatuses, a change instruction to increase the quantity of storage apparatuses may be output. When the storage capacity demanded is smaller than the predetermined threshold for the current quantity of storage apparatuses, a change instruction to decrease the quantity of storage apparatuses may be output.

A user may determine the storage capacity demanded and may input the change instruction concerning the quantity of storage apparatuses (including the quantity of storage apparatuses after a change) by operating the input apparatus 220 such as the keyboard 221 or the mouse 222 depicted in FIG. 2. In this case, the class allocating unit 303 determines the change in the quantity of storage apparatuses and the details of the change based on the change instructions above.

The user may arbitrarily select the storage apparatuses to be changed and may select the storage apparatuses based on external requirements. For example, when the quantity of storage apparatuses is decreased, storage apparatuses having a small quantity of classes allocated thereto are selected with preference. Further, if storage apparatuses that are needed for other uses or storage apparatuses in which a failure has occurred are present, these storage apparatuses are selected.

A specific example of the allocating process by the class allocating unit 303 will be described. In this case, it is assumed that the quantity of storage apparatuses before the variation is “a”. It is also assumed that classes of a quantity equivalent to the common multiple M and to which the files have been allocated by the file allocating unit 302, are equally allocated to “a” storage apparatuses, i.e., M/a classes are allocated to each of the storage apparatuses.

The case where the quantity of storage apparatuses used is changed from “a” to “b” (where a<b) will be described. When the quantity of storage apparatuses used is changed from “a” to “b” (where a<b), the class allocating unit 303 allocates (M/a−M/b) classes of M/a classes allocated to each of the “a” storage apparatuses to (b−a) storage apparatuses subject to the change. In this case, because M is a common multiple of “a” and “b”, the above (M/a) and (M/a−M/b) are necessarily divisible.

By allocating a portion of the classes allocated to the “a” storage apparatuses before the change to an additional (b−a) storage apparatuses increased due to the change, the “b” storage apparatuses after the change have classes equally allocated thereto. Thereby, the relocation of the files executed when the quantity of storage apparatuses is changed from “a” to “b” can be minimized. A specific example of a case where the quantity of storage apparatuses is changed from “a” to “b” (where a<b) will be described in a first example hereinafter.

A case where the quantity of storage apparatuses is changed from “b” to “a” (where a<b) will be described. When the quantity of storage apparatuses is changed from “b” to “a” (where a<b), the class allocating unit 303 allocates (M×(1−a/b)) classes allocated to (b−a) storage apparatuses subject to the change (targeted in the reduction) to the “a” storage apparatuses each having (M/a−M/b) classes.

By allocating the classes allocated to (b−a) storage apparatuses targeted in the reduction to result in “a” storage apparatuses, the “a” storage apparatuses after the reduction have classes equally allocated thereto. Thereby, the relocation of the files executed when the quantity of storage apparatuses is decreased from “b” to “a” can be minimized. A specific example of a case where the quantity of storage apparatuses is changed from “b” to “a” (where a<b) will be described in a second example described hereinafter.

The generating unit 304 has a function of generating, based on the allocation by the class allocating unit 303, an allocation table indicating corresponding relations between the classes to which the files are sufficiently allocated equally and the storage apparatuses to which the classes have been allocated.

FIG. 4 is a diagram of an exemplary allocation table. As depicted in FIG. 4, an allocation table 400 depicts the allocation resulting from an allocation of 12 classes C₁ to C₁₂ equally to two disk apparatuses D₁ and D₂ (see FIG. 1). This is an example of a case where the common multiple M is 12 and the quantity of storage apparatuses currently in-use is two.

More specifically, the allocation table depicts the corresponding relations between the classes C₁ to C₁₂ and the disk apparatuses to which the classes C₁ to C₁₂ are allocated, i.e., the allocation table indicates that the classes C₁ to C₆ are allocated to the disk apparatus D₁ and the classes C₇ to C₁₂ are allocated to the disk apparatus D₂. Though not depicted, the files are sufficiently allocated equally to the classes C₁ to C₁₂.

The transmitting unit 305 has a function of transmitting the allocation table generated by the generating unit 304 to information processing apparatuses that control the reading and writing of files with respect to a storage apparatus. The information processing apparatus is a computer apparatus that includes the storage apparatus and is connected to the distributed storage managing apparatus 101 through the network 110. More specifically, for example, the information processing apparatuses are the servers 102-1 to 102-n depicted in FIG. 1.

The information processing apparatus is a computer apparatus that receives the allocation table transmitted from the distributed storage managing apparatus 101. The information processing apparatus controls the reading and writing of files with respect to the storage apparatus by referring to the allocation table. The reading and writing of files with respect to the storage apparatus executed by reference to the allocation table will be described in a third example described later.

A specific example of a file transfer process will be described. A case where the allocation destinations of classes are changed will be described. In this case, the transmitting unit 305 transmits, to the information processing apparatuses (transfer origins) that control the storage apparatuses to which files have been allocated before the change, transfer requests that identify the files to be transferred and the information processing apparatuses to which the files are to be transferred.

Subsequently, the information processing apparatuses from which files are to be transferred receive the transfer request and from the transfer request, identify the files to be transferred and the information processing apparatuses to which the files are to be transferred. Then, the information processing apparatuses accordingly transfer the files to the appropriate destinations. Thereby, files to be transferred are transferred from information processing apparatuses that are transfer origins to information processing apparatuses that are transfer destinations.

A case where new files are added will be described. In this case, the transmitting unit 305 transmits the new files and a retention request for the new files to the information processing apparatuses (request destinations) that control the storage apparatuses to which the new files are to be allocated. Subsequently, the information processing apparatuses to which the new files are to be allocated receive the retention request and store the new files.

The transmitting unit 305 may transmit the new files and the retention request for the new files to arbitrary information processing apparatuses (request destinations) as another example. In this case, the information processing apparatuses that are request destinations identify the classes to which the new files belong using a predetermined algorithm and compare the classes with the allocation table, thereby identifying the storage apparatuses to which the classes belong (see the third example described hereinafter).

The generating unit 304 may generate, for each of the quantities of storage apparatuses, an allocation table that indicates the allocation resulting from an equal allocation, to the storage apparatuses, of the classes of a quantity equivalent to the common multiple M. That is, for each of the quantities of storage apparatuses, a table chart is generated in advance that has therein corresponding relations between the classes and the storage apparatuses resulting from a re-organization of the storage apparatuses.

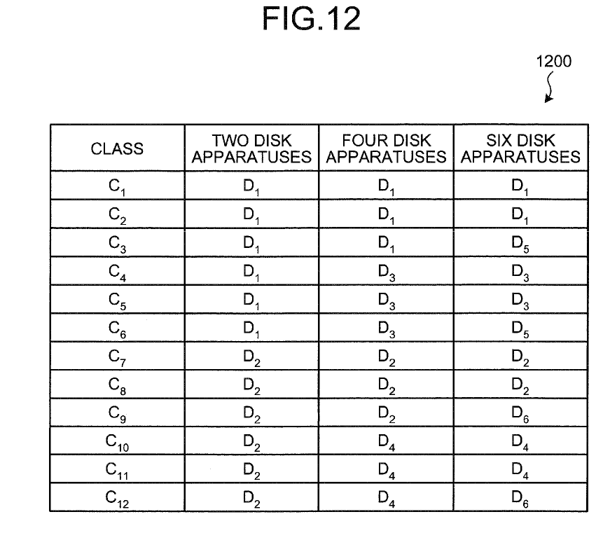

By transmitting the allocation table to each of the information processing apparatuses, the generation and the transmission of the allocation tables corresponding to the quantity of the storage apparatuses in a re-organization are unnecessary each time the storage apparatuses are re-organized. A specific example of the allocation table indicating the allocations resulting for each of the quantities of storage apparatuses will be described hereinafter with reference to FIG. 12.

Processing for generation of an allocation table indicating allocations resulting for each of the quantities of storage apparatuses will be described. In this case, it is assumed that the quantities of storage apparatuses {m₁, m₂ . . . , mₖ} are sorted in ascending order (or descending order). The obtaining unit 301 obtains the common multiple M of the quantities of the storage apparatuses {m₁, . . . , m₂, . . . , mₖ}. Thereafter, the file allocating unit 302 sufficiently allocates the files equally to the classes equivalent in quantity to the common multiple M.

Assuming that a=mᵢ and b=mᵢ₊₁, the class allocating unit 303 repeatedly executes the allocating process of changing the quantity of storage apparatuses from “a” to “b” (where a<b) with “i” varying from i=1 to i=k−1. Finally, the generating unit 304 generates, based on the of allocation results obtained by the class allocating unit 303, an allocation table that indicates the allocations resulting for each of the quantities of storage apparatuses.

FIG. 5 is a flowchart of distributed storage processing performed by the distributed storage managing apparatus according to the first embodiment. As depicted in the flowchart of FIG. 5, the obtaining unit 301 determines whether the common multiple M of the quantities of storage apparatuses to be re-organized has been obtained (step S501).

The distributed storage managing apparatus waits for the common multiple M to be obtained (step S501: NO). When the common multiple M is obtained (step S501: YES), the file allocating unit 302 allocates, according to a predetermined algorithm, the files stored in the storage apparatuses to the classes equivalent in quantity to the common multiple M obtained by the obtaining unit 301 (step S502). The class allocating unit 303 equally allocates to the quantity of storage apparatuses currently in-use, the classes equivalent in quantity to the common multiple M (step S503).

The transfer of the files is executed based on the allocation resulting at step S503 (step S504). Thereafter, the change instruction to change the quantity of storage apparatuses to another quantity that is among the quantities of the storage apparatuses and different from the current quantity is waited for (step S505: NO).

When the change instruction is issued (step S505: YES), the class allocating unit 303 allocates, to the other quantity of storage apparatuses and by class, the files that have been allocated to the M classes by the file allocating unit 302 (step S506). The transfer of the files is executed based on the allocation resulting at step S506 (step S507) and a series of the processing according to the flowchart comes to an end.

According to the first embodiment, the transfer of the files can be executed by class through a sufficiently equal allocation of the files to the classes equivalent in quantity to the common multiple M. More specifically, by allocating the classes to logical disks, the files belonging to each of the classes can be moved collectively when the quantity of storage apparatuses is changed. Thereby, the relocation of the files executed when the quantity of storage apparatuses to be used is changed can be reduced.

The allocation table indicating the allocation of the classes can be transmitted to the information processing apparatuses that control the storage apparatuses. Thereby, the information processing apparatuses can refer to the allocation table and, control the reading and writing of the files with respect to the storage apparatuses. That is, when an operation such as the addition of new files and the referencing of a file is executed, inquiries concerning the allocation need not be made to the distributed storage managing apparatus 101, thereby enabling the prevention of bottle necks.

The allocation table indicating the allocation of the classes may be generated for each of the quantities of storage apparatuses to be re-organized, and the allocation table can be transmitted to the information processing apparatuses. Thereby, the generation and the transmission of an allocation table corresponding to the quantity of the storage apparatuses in a re-organization are unnecessary each time the quantity of storage apparatuses is changed.

The relations between the classes and the files do not change regardless of changes in the quantity of storage apparatuses. Therefore, when the quantity of storage apparatuses is changed, the allocation of files to classes is unnecessary and therefore, the corresponding relations between the classes and the files can be effectively managed. Further, when the quantity of storage apparatuses is changed, the re-calculation of the hash value for each file is unnecessary and therefore, processing necessary for re-organization can be omitted.

According to the first embodiment, files are sufficiently allocated equally to classes equivalent in quantity to the common multiple M. However, the files may be equally allocated to the classes equivalent in quantity to the common multiple M based on the volume of data in each file. More specifically, the files may be allocated to the classes equivalent in quantity to the common multiple M such that the total volume of data allocated to each class is for the same for all the classes.

A case where the quantity of disk apparatuses D₁ to Dₙ is changed from two (a=2) to four (b=4) in the storage system 100 depicted in FIG. 1 will be taken as an example and described in the first example. The quantity of disk apparatuses D₁ to Dₙ is increased in response to an increase in the storage capacity demanded.

The manager of the storage system 100 sets quantities of disk apparatuses D₁ to Dₙ to be re-organized as a part of pre-operation preparation. Here, quantities of disk apparatuses {2, 4, 6} are set. As a result, the obtaining unit 301 obtains the least common multiple M (M=12) of the quantities of the disk apparatuses {2, 4, 6}.

Classes of a quantity equivalent to the least common multiple M, that is, 12 classes C₁ to C₁₂ are defined. The file allocating unit 302 sufficiently allocates the files equally to the classes C₁ to C₁₂. In this case, the files include 24 files f₁ to f₂₄. More specifically, the file allocating unit 302 allocates two files to each of the classes C₁ to C₁₂.

“f₁ to f₂₄” are file numbers given to the files. “C₁ to C₁₂” are class numbers given to the classes. Thereafter, the quantity of disk apparatuses D₁ to Dₙ that is “a” in the initial state is set. More specifically, for example, a user arbitrarily selects a quantity of disk apparatuses from among the quantities of disk apparatuses {2, 4, 6}. In this case, two (a=2) disk apparatuses D₁ and D₂ are set.

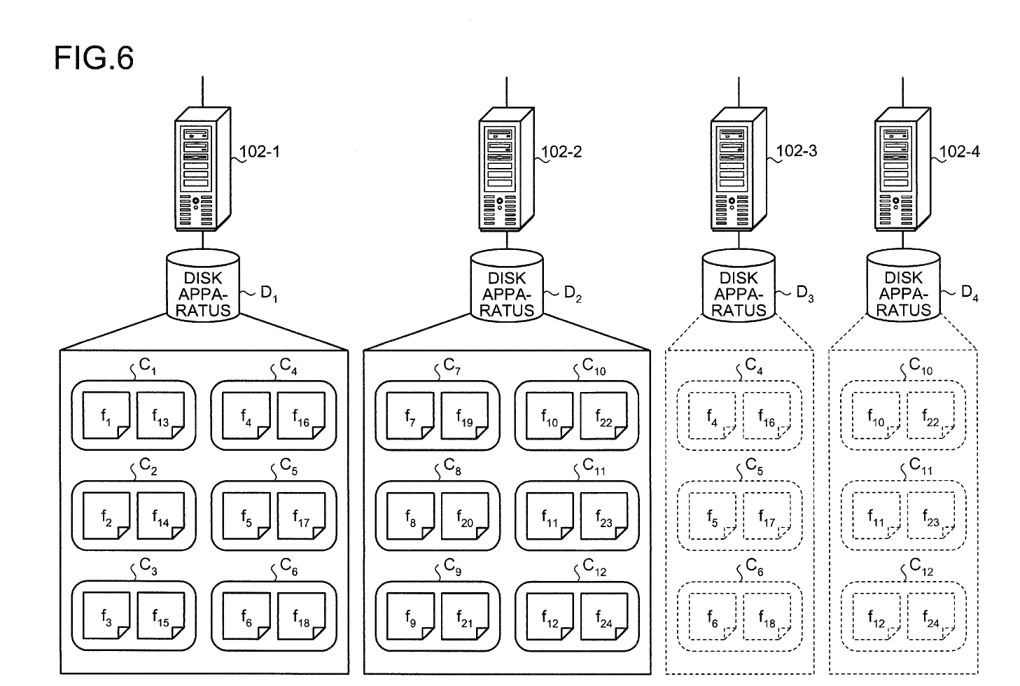

FIG. 6 is a schematic of an overview of distributed storage processing according to the first example of the first embodiment. As depict in FIG. 6, the files f₁ to f₂₄ are stored in the disk apparatuses D₁ and D₂ that are respectively included in the servers 102-1 and 102-2.

In this case, the files f₁ to f₂₄ are equally stored among the two disk apparatuses D₁ and D₂ by class (the classes C₁ to C₁₂). More specifically, for example, according to a predetermined algorithm, every six classes in ascending order of class number are allocated sequentially to disk apparatuses D₁ and D₂ in ascending order of disk number. Thus, the classes C₁ to C₆ are allocated to the disk apparatus D₁ and the classes C₇ to C₁₂ are allocated to the disk apparatus D₂. As a result, the files f₁ to f₂₄ are stored equally among the disk apparatuses D₁ and D₂ each storing 12 files therein.

Thereafter, the quantity of disk apparatuses D₁ and D₂ is changed from two, which is the current quantity, to four. In this case, disk apparatuses D₃ and D₄ respectively included in the servers 102-3 and 102-4 are added. Here, the class allocating unit 303 allocates three classes of the six classes that are allocated to each of the two disk apparatuses D₁ and D₂ to each of the two disk apparatuses D₃ and D₄ subject to the change.

More specifically, for example, the three (M/a−M/b) classes, in descending order of class number, of the six (M/a) classes that are allocated to each of the disk apparatuses D₁ and D₂ are selected to be relocated. That is, the classes C₄, C₅, and C₆ allocated to the disk apparatus D₁ and the classes C₁₀, C₁₁, and C₁₂ allocated to the disk apparatus D₂ are selected as the classes to be relocated.

Thereafter, every three classes in ascending order of class number of the six (M×(1−a/b)) classes selected as the classes to be relocated are allocated to each of the disk apparatuses D₃ and D₄ sequentially in ascending order of disk number. In this case, the classes C₄, C₅, and C₆ are allocated to the disk apparatus D₃ and the classes C₁₀, C₁₁, and C₁₂ are allocated to the disk apparatus D₄.

The files belonging to the classes are transferred respectively to a corresponding disk apparatus based on the allocation result by the class allocating unit 303. As a result, each of the disk apparatuses stores the files therein. More specifically, for example, as the result of the allocation of the class C₄ to the disk apparatus D₃, the files f₄ and f₁₆ belonging to the class C₄ are transferred to the disk apparatus D₃.

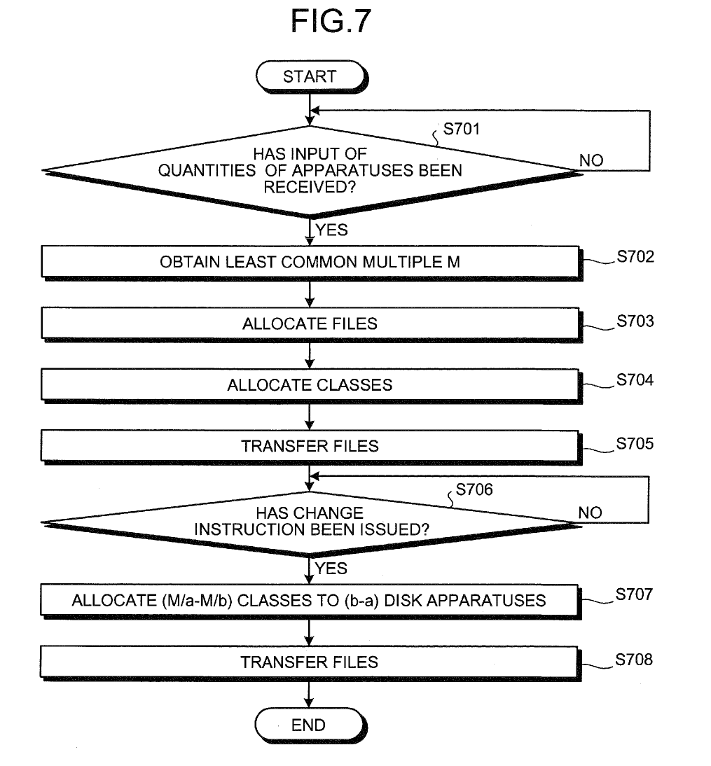

FIG. 7 is a flowchart of the distributed storage processing according to the first example of the first embodiment. As depicted in the flowchart of FIG. 7, whether input of quantities of disk apparatuses D₁ to Dₙ to be re-organized has been received is determined (step S701).

Input of the quantities of the disk apparatuses is waited for (step S701: NO). When the input is received (step S701: YES), the obtaining unit 301 calculates the least common multiple of the quantities of the disk apparatuses {2, 4, 6} input at step S701 and thereby, obtains the least common multiple M (M=12) (step S702).

Thereafter, the file allocating unit 302 sufficiently allocates the files f₁ to f₂₄ stored in the “a” (a=2) disk apparatuses D₁ and D₂ equally to classes of a quantity equivalent to the least common multiple M obtained at step S702, that is, 12 classes C₁ to C₁₂ (step S703). The class allocating unit 303 allocates the classes C₁ to C₁₂ equally to the “a” (a=2) disk apparatuses D₁ and D₂ (step S704).

The files f₁ to f₂₄ are transferred to “a” (a=2) disk apparatuses D₁ and D₂ by class based on the allocation (allocation table) by the class allocating unit 303 at step S704 (step S705).

Thereafter, a change instruction instructing a change in the quantity of disk apparatuses to be used is waited for (step S706: NO). When a change instruction to change the quantity of disk apparatuses from “a” (a=2) to “b” (b=4) is received (step S706: YES), the class allocating unit 303 allocates (M/a−M/b) classes of the M/a classes allocated to each of the “a” disk apparatuses D₁ and D₂ to each of the (b−a) disk apparatuses D₃ and D₄ subject to the change (step S707).

The files f₄ to f₆, f₁₆ to f₁₈, f₁₀ to f₁₂, and f₂₂ to f₂₄ selected as the files to be relocated are transferred to the (b−a) disk apparatuses D₃ and D₄ by class based on the allocation (allocation table) by the class allocating unit 303 at step S707 (step S708) and a series of the processing according to the flowchart comes to an end.

According to the first example, the relocation of the files executed when the quantity of disk apparatuses D₁ to Dₙ is changed from “a” to “b” (where a<b) can be minimized. More specifically, the number of files that need to be relocated can be minimized by executing the relocation of the files by class (the (M/a−M/b) classes).

For example, when the quantity of disk apparatuses D₁ to Dₙ is changed from nine to 10, according to the algorithm-based technique described in [BACKGROUND], 90% of the files require relocation. However, according to the approach described in the first example, 10% of the files (logically, the lowest value) require relocation.

A case where the quantity of disk apparatuses D₁ to Dₙ is changed from four (b=4) to two (a=2) in the storage system 100 depicted in FIG. 1 will be taken as an example and described in the second example. The quantity of the disk apparatuses D₁ to Dₙ is decreased in response to a decrease in the storage capacity demanded. Illustration and description of parts identical to those described in the first example will be omitted.

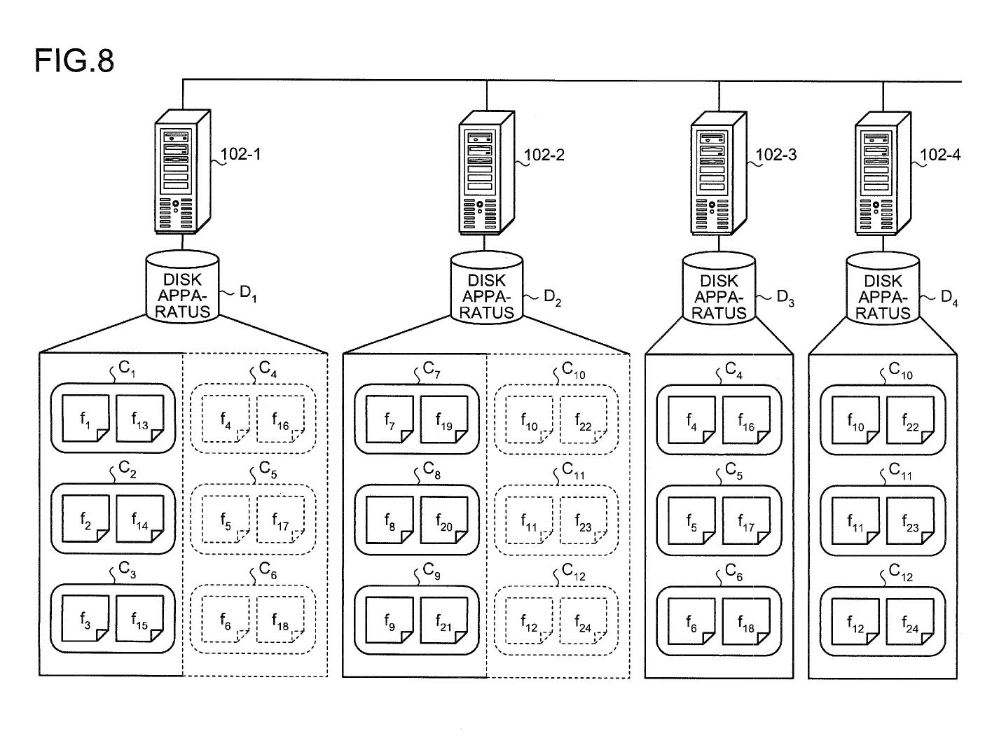

FIG. 8 is a schematic of an overview of distributed storage processing in the second example of the first embodiment. As depicted in FIG. 8, the files f₁ to f₂₄ are equally stored among the four disk apparatuses D₁ and D₄ by class (the classes C₁ to C₁₂).

Subsequently, the quantity of disk apparatuses D₁ to D₄ is changed from four, which is the current quantity, to two. In this case, the disk apparatuses D₃ and D₄ each having the largest disk numbers among the four disk apparatuses D₁ to D₄ are subject to the change. The class allocating unit 303 equally allocates the six classes allocated to the two disk apparatuses D₃ and D₄ to the two disk apparatuses D₁ and D₂.

More specifically, for example, the three (M×(1/a−1/b)) classes allocated to each of the disk apparatuses D₃ and D₄ are selected as the classes to be relocated. That is, the classes C₄, C₅, and C₆ allocated to the disk apparatus D₃ and the classes C₁₀, C₁₁, and C₁₂ allocated to the disk apparatus D₄ are selected as the classes to be relocated.

Thereafter, every three (M/a−M/b) classes in ascending order of class number of the six (M×(1−a/b)) classes C₄ to C₆ and C₁₀ to C₁₂ selected as the classes to be relocated are allocated sequentially to each of the disk apparatuses D₁ and D₂ in ascending order of disk number. In this case, the classes C₄, C₅, and C₆ are allocated to the disk apparatus D₁ and the classes C₁₀, C₁₁, and C₁₂ are allocated to the disk apparatus D₂.

The files belonging to the classes are transferred respectively to corresponding disk apparatuses based on the allocation by the class allocating unit 303 and the files are stored in the disk apparatuses. More specifically, for example, as the result of the allocation of the class C₄ to the disk apparatus D₁, the files f₄ and f₁₆ belonging to the class C₄ are transferred to the disk apparatus D₁.

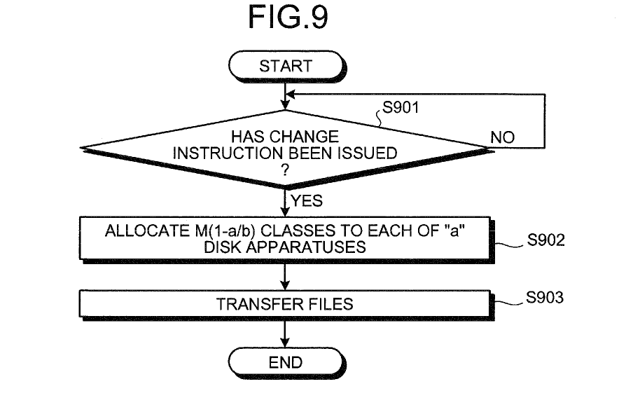

Processing executed after a change instruction to decrease the quantity of disk apparatuses D₁ to Dₙ is issued will be described. FIG. 9 is a flowchart of the storage processing in the second example of the first embodiment.

As depicted in the flowchart of FIG. 9, the change instruction to vary the quantity of disk apparatuses to be used is waited for (step S901: NO). When the change instruction to vary the quantity of disk apparatuses from “b” (b=4) to “a” (a=2) is received (step S901: YES), the class allocating unit 303 allocates every (M/a−M/b) classes of the (M×(1−a/b)) classes allocated to the (b−a) disk apparatuses D₃ and D₄ subject to the change to each of the “a” disk apparatuses D₁ and D₂ (step S902).

The files f₄ to f₆, f₁₆ to f₁₈, f₁₀ to f₁₂, and f₂₂ to f₂₄ selected as the files to be relocated are transferred to the “a” disk apparatuses D₁ and D₂ by class, based on the allocation by the class allocating unit 303 at step S902 (step S903) and a series of the processing according to the flowchart comes to an end.

According to the second example, the relocation of the files executed when the quantity of disk apparatuses D₁ to Dₙ is changed from “b” to “a” (where a<b) can be minimized. More specifically, the number of files that need to be relocated can be minimized by executing the relocation of the files by class (the (M/a−M/b) classes).

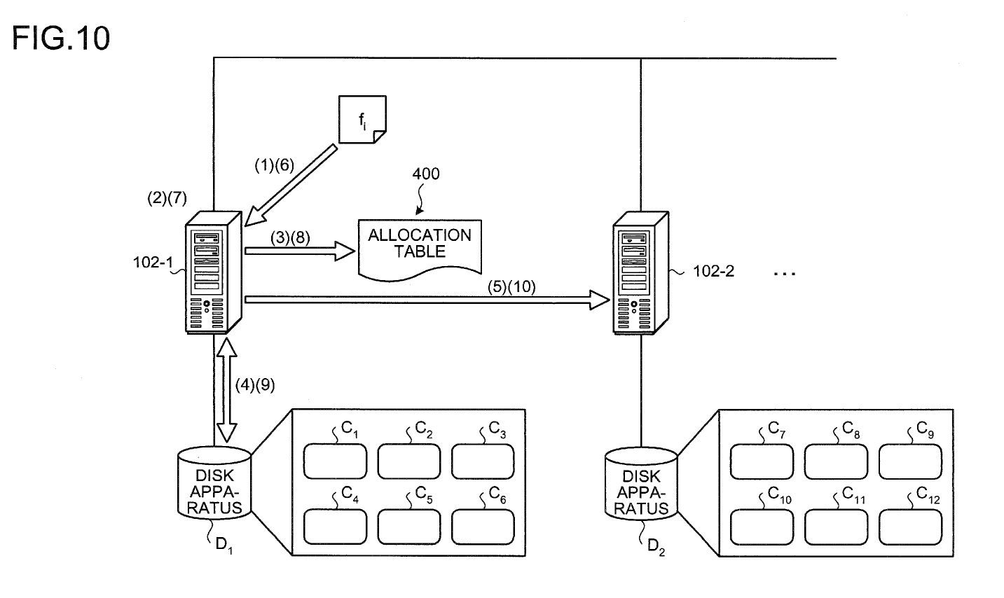

In the third example, an exemplary operation of the servers 102-1 to 102-n using the allocation table generated by the generating unit 304 will be described. FIG. 10 is a schematic of an overview of the exemplary operation of the servers.

In FIG. 10, the classes C₁ to C₁₂ are allocated equally to the disk apparatuses D₁ and D₂ respectively included in the servers 102-1 and 102-2. The servers 102-1 and 102-2 respectively control the reading and writing of files with respect the disk apparatuses D₁ and D₂ by referring to the allocation table 400 depicted in FIG. 4.

Processing by the servers 102-1 to 102-n executed when a writing (write) request for a new file fᵢ is issued will be described. A case where a writing request for the new file fₙ is issued from external computer apparatuses (for example, the external apparatuses 103-1 to 103-n depicted in FIG. 1) to the server 102-1 will be described. The allocation table 400 includes information that indicates the class to which the new file fᵢ is to be allocated.

When the server 102-1 receives the writing request for the new file fᵢ from an external computer apparatus (1) the server 102-1 determines, by a hash function determined in advance, the class C₁ to C₁₂ to which the new file fᵢ is to be allocated (2). The server 102-1, by referring to the allocation table 400, determines the allocation destination (the disk apparatus D₁ or D₂) of the class to which the new file fᵢ is allocated (3).

In this case, if the allocation destination of the class (for example, the class C₁) is the disk apparatus D₁, the new file f₁ is written into the disk apparatus D₁ (4). On the other hand, if the allocation destination of the class (for example, the class C₁₂) is the disk apparatus D₂, the new file f₁, together with the writing request, is transferred to the server 102-2 (5).

Processing executed by the servers 102-1 to 102-n when a reference (read) request for the file fⱼ is issued will be described. The case where a reference request for the file fⱼ is issued from an external computer apparatus to the server 102-1 will be described. The allocation table 400 includes information that indicates the class to which the new file fⱼ is to be allocated.

When the server 102-1 receives the reference request for the new file fⱼ from an external computer apparatus (6), the server 102-1 determines, by a hash function determined in advance, the class C₁ to C₁₂ to which the new file fⱼ is to be allocated (7). The server 102-1, by referring to the allocation table 400, determines the disk apparatus D₁ or D₂ that is the allocation destination of the class to which the new file fⱼ is allocated (8).

In this case, when the allocation destination of the class (for example, the class C₁) is the disk apparatus D₁, the new file fⱼ is read from the disk apparatus D₁ (9). On the other hand, when the allocation destination of the class (for example, the class C₁₂) is the disk apparatus D₂, the reference request for the file fⱼ is transferred to the server 102-2 (10).

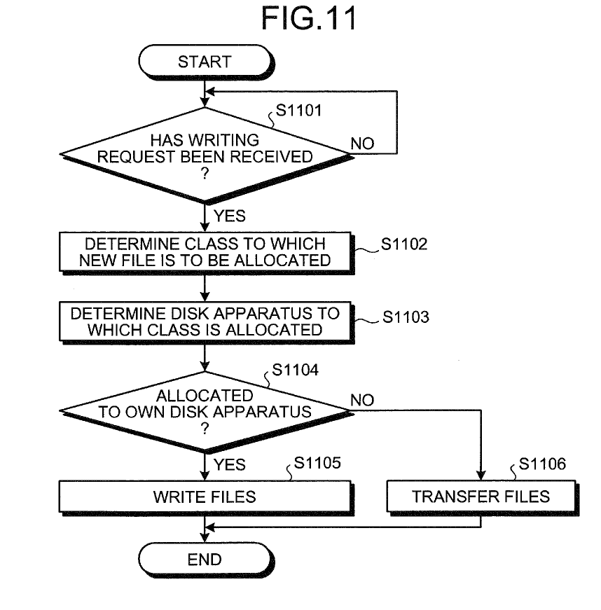

Information processing by the servers 102-1 to 102-n will be described. Writing processing executed when a writing request for the file fᵢ is issued will be taken as an example and described. FIG. 11 is a flowchart of writing processing by the servers.

As depicted in the flowchart of FIG. 11, an interface determines whether the writing request for the new file fᵢ has been received from an external computer apparatus (step S1101). Reception of the writing request is waited for (step S1101: NO). When the writing request is received (step S1101: YES), the class C₁ to C₁₂ to which the new file fᵢ is to be allocated is determined by referring to the allocation table 400 (step S1102).

Subsequently, the disk apparatus D₁, D₂ that is the allocation destination of the class determined at step S1102 is determined (step S1103). When the disk apparatus D₁, D₂ that that has received the writing request for the new file fᵢ is the allocation destination, e.g., the disk apparatus D₁ (step S1104: YES), the new file fᵢ is written into the disk apparatus D₁ using a disk drive (step S1105) and a series of the processing according to the flowchart comes to an end.

At step S1104, when the disk apparatus D₁, D₂ that has received the writing request for the new file fit, e.g., the disk apparatus D₁, is not the allocation destination (step S1104: NO), the new file fit, together with the writing request, is transferred to the server 102-2 using the interface (step S1106) and a series of the processing according to the flowchart comes to an end.

According to the third example, the servers 102-1 to 102-n can to refer to the allocation table 400 transmitted from the distributed storage managing apparatus 101 and control the reading and writing of files with respect to the disk apparatuses D₁ to Dₙ. Thus, during ordinary operation, inquiries concerning allocation need not be made to the distributed storage managing apparatus 101, thereby enabling bottle necks to be prevented.

An allocation table indicating, for each of the quantities of the disk apparatuses to be re-organized, the allocation resulting from an equal allocation of the classes equivalent in quantity to the common multiple M to the disk apparatuses may be used as the allocation table that is referenced.

FIG. 12 is a diagram another exemplary allocation table. As depicted in FIG. 12, an allocation table 1200 depicts, for each of the quantities of the disk apparatuses D₁ to Dₙ subject to re-organization, the allocation resulting from an equal allocation of classes of a quantity equivalent to the least common multiple M (12 classes) to the disk apparatuses D₁ to Dₙ.

More specifically, for example, when the quantity of disk apparatuses D₁ to Dₙ is two, the classes C₁ to C₆ are allocated to the disk apparatus D₁ and the classes C₇ to D₁₂ are allocated to the disk apparatus D₂. When the quantity of disk apparatuses D₁ to Dₙ is four, the classes C₁ to C₃ are allocated to the disk apparatus D₁, the classes C₄ to C₆ are allocated to the disk apparatus D₃, the classes C₇ to C₉ are allocated to the disk apparatus D₂, and the classes C₁₀ to C₁₂ are allocated to the disk apparatus D₄.

Thus, the servers 102-1 to 102-n can control the reading and writing of files with respect to the disk apparatuses D₁ to Dₙ by referring to the allocation table 1200 according to the quantity of disk apparatuses D₁ to Dₙ. The distributed storage managing apparatus 101 does not need to generate and transmit an allocation table that corresponds to the quantity of the disk apparatuses D₁ to Dₙ each time the quantity of disk apparatuses D₁ to Dₙ is changed.

A distributed storage managing apparatus 101 according to a second embodiment will be described. Although the quantity of storage apparatuses to be re-organized needs to be determined in the first embodiment, an approach of minimizing the relocation of files without determining the quantity of storage apparatuses to be re-organized is proposed in the second embodiment.

The approach described in the first embodiment cannot cope with a state where determination of the quantity of the storage apparatuses to be re-organized is difficult or where re-organization must be executed with a quantity of storage apparatuses that is not planned. For example, it is assumed that the quantities of storage apparatuses to be re-organized are three that are {2, 4, 6} and “12” is selected as the common multiple M of the three.

In such a case, the quantities of storage apparatuses that are changeable thereafter are limited to the divisors of “12” and, therefore, re-organization using the storage apparatuses of another quantity (for example, five) cannot be executed. In the second embodiment, an approach of decreasing the number of files that need to be relocated without designating in advance the quantity of storage apparatuses to be re-organized when the quantity of storage apparatuses is changed is proposed.

Details of the processing by the control unit (the obtaining unit 301 to the transmitting unit 305) of the distributed storage managing apparatus 101 according to the second embodiment will be described. Components identical to those described in the first embodiment will be given the same corresponding reference numerals and description thereof will be omitted.

The obtaining unit 301 obtains the quantity M of classes to be allocated with an arbitrary group of files. The quantity M of classes is an arbitrary fixed value. More specifically, for example, a specific number of times (for example, eight times or ten times) as large as the maximum quantity of usable storage apparatuses at the start of the operation of the storage system 100 may also be used.

The variability of the quantity of classes to be allocated to each of the storage apparatuses decreases as the quantity M of classes obtained increases, and the variability of the quantity of classes to be allocated to each of the storage apparatuses increases as the quantity M of classes decreases. The quantity M of classes may also be directly input into the distributed storage managing apparatus 101 by a user operation of the input apparatus 220 depicted in FIG. 2, or may be obtained from an external apparatus not depicted.

The file allocating unit 302 sufficiently allocates the arbitrary files equally to the classes of the quantity M obtained by the obtaining unit 301 according to a predetermined algorithm. More specifically, for example, one sufficiently even hash function h( ) is determined that determines one integer from a character string expressing the file name of each file and the files are classified into M classes by congruent (mod M) using the quantity M as the modulus.

The class allocating unit 303 equally allocates the M classes allocated with the files by the file allocating unit 302 to storage apparatuses currently in-use. More specifically, the quantity of classes to be allocated to each of the storage apparatuses is determined using an algorithm that satisfies the condition that the difference between the maximum quantity of classes and the minimum quantity of classes allocated to each of the storage apparatuses is “one at most”.

More specifically, for example, the quantity of classes to be allocated to each of the storage apparatuses may be determined using the following algorithm “A” (A-1 and A-2) that satisfies the above condition. It is assumed that the quantity of storage apparatuses currently in-use is a

(A-1) The quotient obtained by dividing the quantity of classes M by the quantity of storage apparatuses “a” is denoted by “q” and the remainder obtained thereby is denoted by “r”.

(A-2) The quantity of classes to be allocated to r storage apparatuses in ascending order of disk number (for example, D₁ to Dₙ) given to the storage apparatuses is determined to be (q+1) and the quantity of classes to be allocated to the remaining storage apparatuses is determined to be q.

Thereafter, the classes of the above determined quantity of classes are allocated to “a” storage apparatuses using an arbitrary algorithm. More specifically, for example, the classes may also be allocated in ascending order of class number to the storage apparatuses each having a relatively small disk number.

When the quantity of storage apparatuses used is changed from “a” to “b” (where a<b), the class allocating unit 303 determines the quantity of classes to be allocated to the storage apparatuses using an algorithm that satisfies the following conditions (1) to (3).

(1) The difference between the maximum quantity of classes and the minimum quantity of classes allocated to each of the storage apparatuses is “one at most”.

(2) After a change (after an increase), the quantity of classes to be allocated to the storage apparatuses subject to the increase is equal to or smaller than the quantity of classes of the existing storage apparatuses.

(3) The quantity of classes of the existing storage apparatuses is not increased compared to that before the change (the increase).

More specifically, for example, the quantity of classes to be allocated to each of the storage apparatuses may be determined using the following algorithm B (B-1, B-2, and B-3) that satisfies the above conditions (1) to (3).

(B-1) The quotient obtained by dividing the quantity M of classes by the quantity of storage apparatuses “b” is denoted by “q₁” and the remainder obtained thereby is denoted by “r₁”.

(B-2) Assuming that the quantity of classes allocated to (b−a) storage apparatuses subject to the increase is zero, the “b” storage apparatuses are sorted such that the quantities of classes allocated to those apparatuses are in descending order.

(B-3) The quantity of classes to be allocated to r₁ storage apparatuses from the head of the sorted b storage apparatuses is determined as (q₁+1) and the quantity of classes to be allocated to the remaining storage apparatuses is determined as q₁.

As the result of the determination of the quantity of classes of each of the storage apparatuses according to the above algorithm B, classes to be relocated are selected from the classes allocated to the storage apparatuses whose quantities of classes are to be decreased after the increase. More specifically, for example, classes may be selected in descending order of class number as the classes to be relocated from the classes allocated to the storage apparatuses whose quantities of classes are to be decreased.

Only the classes of the quantity that is determined according to the above algorithm B of the classes to be relocated are allocated to the storage apparatuses subject to the increase according to an arbitrary algorithm. More specifically, for example, the classes to be relocated may be sequentially allocated in ascending order of class number to the disk apparatuses having the smallest disk numbers among the storage apparatuses subject to the increase.

Thereby, the relocation of the files executed when the quantity of storage apparatuses used is increased from “a” to “b” can be minimized. A specific example of a case where the quantity of storage apparatuses is changed from “a” to “b” (where a<b) will be described in a first example of the second embodiment described hereinafter.

When the quantity of storage apparatuses used is changed from “b” to “a” (where a<b), the class allocating unit 303 determines the quantity of classes to be allocated to each of the storage apparatuses using an algorithm that satisfies the following conditions (4) and (5).

(4) The difference between the maximum quantity of classes and the minimum quantity of classes allocated to each of the storage apparatuses is “one at most”.

(5) The quantity of classes of the storage apparatuses other than the storage apparatuses targeted in the reduction among the existing storage apparatuses is not decreased compared to that before the change (reduction).

More specifically, for example, the quantity of classes to be allocated to each of the storage apparatuses may be determined using the following algorithm C(C-1, C-2, and C-3) that satisfies the above conditions (4) and (5).

(C-1) The quotient obtained by dividing the quantity M of classes by the quantity of storage apparatuses after the change (reduction) “a” is denoted by “q₂” and the remainder obtained thereby is denoted by “r₂”.

(C-2) The “a” storage apparatuses after the change (reduction) are sorted such that the quantities of classes allocated before the change (reduction) are in descending order.

(C-3) The quantity of classes to be allocated to r₂ storage apparatuses from the head of the sorted “a” storage apparatuses is determined as (q₂+1) and the quantity of classes to be allocated to the remaining storage apparatuses is determined as q₂.

The classes allocated to the storage apparatuses targeted in the reduction are selected as the classes to be relocated. Only the classes of the quantity that is determined according to the above algorithm C of the classes to be relocated are allocated to the storage apparatuses after the change (reduction) according to an arbitrary algorithm. More specifically, for example, the classes to be relocated may be sequentially allocated in ascending order of class number to the disk apparatuses having the smallest disk numbers among the storage apparatuses after the change (reduction).

Thus, the relocation of the files executed when the quantity of storage apparatuses used is decreased from “b” to “a” can be minimized. A specific example of a case where the quantity of storage apparatuses is changed from “b” to “a” (where a<b) will be described in a second example of the second embodiment described hereinafter.

According to the second embodiment, the relocation of the files executed when the quantity of storage apparatuses is changed can be minimized without designating in advance the quantity of storage apparatuses to be re-organized. As a result, a state where determination of the quantity of the storage apparatuses to be re-organized is difficult or where re-organization must be executed with a quantity of storage apparatuses that is not planned can be flexibly coped with.

According to the approach of the second embodiment, a variability that is at most one in the quantity of classes to be allocated to each of the storage apparatuses is generated. However, the variability is relatively reduced by increasing the quantity M of classes.

In a fourth example, the case where the quantity of disk apparatuses D₁ to Dₙ is changed from five (a=5) to seven (b=7) in the storage system 100 depicted in FIG. 1 will be taken as an example and described.

The manager of the storage system 100 sets an arbitrary quantity M of classes as pre-operation preparation. In this case, “17” is set as the quantity of classes. As a result, the obtaining unit 301 obtains the quantity of classes M (M=17).

Classes of the quantity M, that is, 17 classes C₁ to C₁₇ are defined. The file allocating unit 302 sufficiently allocates an arbitrary group of files equally to the classes C₁ to C₁₇. Thereafter, the quantity of disk apparatuses D₁ to Dₙ in the initial state “a” is set. In this case, five (a=5) disk apparatuses D₁ to D₅ are set.

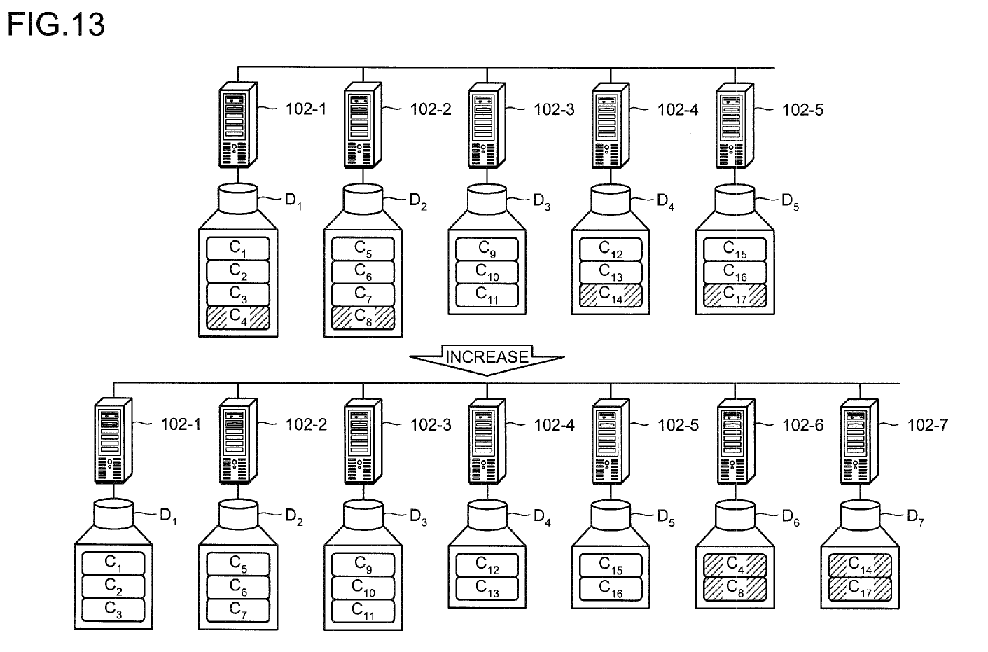

FIG. 13 is a schematic of an overview of distributed storage processing in the fourth example of the second embodiment.

As depicted in FIG. 13, the classes C₁ to C₁₇ are allocated to the disk apparatuses D₁ to D₅ that are respectively included in the servers 102-1 to 102-5. More specifically, according to the above algorithm “A”, four classes are allocated to each of the disk apparatuses D₁ and D₂ and three classes are allocated to each of the disk apparatuses D₃ to D₅. As the result of the allocation of the classes C₁ to C₁₇, the files belonging to the classes C₁ to C₁₇ are stored in the disk apparatuses D₁ to D₅.

The quantity of disk apparatuses D₁ to D₅ is changed from five, which is the current quantity, to seven. In this case, the disk apparatuses D₆ and D₇ respectively included in the servers 102-6 and 102-7 are added. According to the above algorithm B, the quantity of classes to be allocated to each of the disk apparatuses D₁ to D₇ after the change is determined.

In this case, the quantity of classes of each of the disk apparatuses D₁ to D₃ is three and the quantity of classes of each of the disk apparatuses D₄ to D₇ is two. The classes to be relocated are selected from the classes allocated to the disk apparatuses D₁, D₂, D₄, and D₅ whose quantities of classes are to be decreased. The classes to be relocated are allocated to the disk apparatuses D₆ and D₇.

In this case, the class allocating unit 303 allocates one class allocated to each of the disk apparatuses D₁ and D₂, and one class allocated to each of the disk apparatuses D₄ and D₅, respectively to the additional two disk apparatuses D₆ and D₇.

More specifically, one class in descending order of class number among the four classes allocated to each of the disk apparatuses D₁ and D₂ is selected from each of the disk apparatuses D₁ and D₂ to be relocated (C₄ and C₈). One class in descending order of class number among the three classes allocated to each of the disk apparatuses D₄ and D₅ is also selected from each of the disk apparatuses D₄ and D₅ to be relocated (C₁₄ and C₁₇).

The classes (C₄, C₈, C₁₄, and C₁₇) selected to be relocated are allocated sequentially in ascending order of class number to the additional two disk apparatuses D₆ and D₇. In this case, the classes are allocated to the disk apparatuses D₆ and D₇ each having a relatively small disk number. In this case, the classes C₄ and C₈ are allocated to the disk apparatus D₆ and the classes C₁₄ and C₁₇ are allocated to the disk apparatus D₇.

Using an arbitrary approach and based on the allocation by the class allocating unit 303, the files belonging to the classes C₄, C₈, C₁₄, and C₁₇ are transferred to the disk apparatuses D₆ and D₇ that are the allocation destinations for the classes. As a result, the files are stored in the disk apparatuses D₆ and D₇. For example, as a result of the allocation of the class C₄ to the disk apparatus D₆, the files belonging to the class C₄ are transferred from the disk apparatus D₁ to the disk apparatus D₆.

Distributed storage processing in the fourth example of the second embodiment will be described. Detailed processing of a pre-operation preparation process will be described. The quotient obtained by dividing the quantity M of classes by the quantity of disk apparatuses D₁ to D₅ “a” is denoted by “q” and the remainder obtained thereby is denoted by “r”.

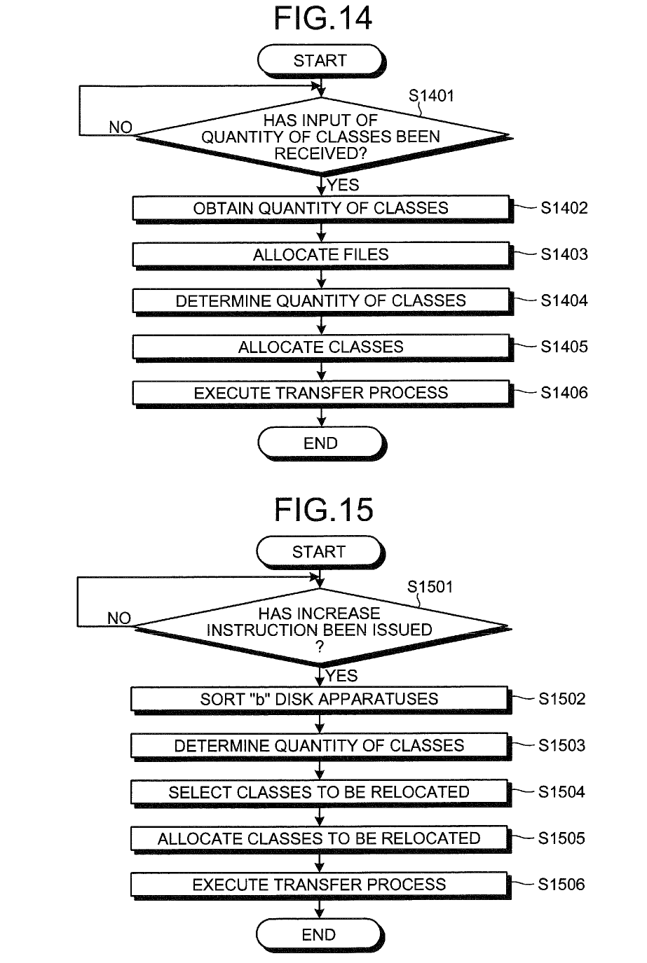

FIG. 14 is a flowchart detailing the processing of the pre-operation preparation process. As depicted in the flowchart of FIG. 14, whether input of an arbitrary quantity M of classes has been received is determined (step S1401). The input of the quantity M of classes is waited for (step S1401: NO). When the input is received (step S1401: YES), the obtaining unit 301 obtains the quantity M of classes (M=17) input at step S1401 (step S1402).

Thereafter, the file allocating unit 302 sufficiently allocates “a” files held by the storage system 100 equally to the quantity M of classes obtained at step S1402, that is, 17 classes C₁ to C₁₇ (step S1403).

The class allocating unit 303 determines the quantity of classes to be allocated to the r storage apparatuses in ascending order of the disk numbers D₁ to Dₙ respectively given to the disk apparatuses D₁ to D₆, as (q+1) and the quantity of classes to be allocated to the remaining storage apparatuses as q (step S1404). Thereafter, the classes C₁ to C₁₇ are allocated to the “a” (a=5) disk apparatuses D₁ to D₅ in the initial state based on the quantity of classes determined at step S1404 (step S1405).

A transfer process of transferring the files to the disk apparatuses D₁ to D₅ by class is executed (step S1406) based on the allocation (allocation table) by the class allocating unit 303 at step S1405 (step S1406) and a series of the processing according to the flowchart comes to an end.

Distributed storage processing executed when five disk apparatuses D₁ to D₅ currently in-use are increased to seven disk apparatuses D₁ to D₇ will be described. The quotient obtained by dividing the quantity M of classes by the quantity of disk apparatuses D₁ to D₇ “b” (b=7) after the increase is denoted by “q₁” and the remainder obtained thereby is denoted by “r₁”.

FIG. 15 is a flowchart of distributed storage processing for the increase. As depicted in the flowchart of FIG. 15, whether input of an increase instruction instructing an increase in the quantity of disk apparatuses used has been received is determined (step S1501).

Reception of the increase instruction is waited for (step S1501: NO). When the increase instruction to change the quantity of disk apparatuses from “a” (a=5) to “b” (b=7) is received (step S1501: YES), assuming that the quantity of classes allocated to the disk apparatuses D₆ to D₇ to be increased is zero, the class allocating unit 303 sorts the disk apparatuses D₁ to D₇ such that the quantities of classes allocated to the apparatuses are in descending order (step S1502).

The class allocating unit 303 determines the quantity of classes to be allocated to the r₁ (three) disk apparatuses D₁ to D₃ from the head of the sorted “b” disk apparatuses D₁ to D₇, as (q₁+1) (three) and the quantity of classes to be allocated to the remaining disk apparatuses D₄ to D₇, as q₁ (two) (step S1503).

Thereafter, the class allocating unit 303 selects, based on the quantity of classes determined at step S1503, the classes C₄, C₈, C₁₄, and C₁₇ to be relocated from the classes C₁ to C₁₇ allocated to the disk apparatuses D₁, D₂, D₄, and D₅ whose quantities of classes are to be decreased (step S1504) and the class allocating unit 303 allocates the selected classes C₄, C₇, C₁₄, and C₁₇ to the disk apparatuses D₆ and D₇ only in the quantity determined at step S1503 (step S1505).

The transfer process of transferring the files belonging to the classes C₄, C₈, C₁₄, and C₁₇ to be relocated to the disk apparatuses D₆ and D₇ by class is executed based on the allocation (allocation table) by the class allocating unit 303 at step S1505 (step S1506) and a series of the processing according to the flowchart comes to an end.

According to the fourth example, the relocation of the files executed when the quantity of disk apparatuses D₁ to Dₙ is changed from “a” (a=5) to “b” (b=7) can be minimized. More specifically, the relocation of the files can be minimized as a result of determining the quantity of classes according to the algorithm B and selecting the classes to be relocated such that the relocation of the classes is minimized.

In the example depicted in FIG. 13, only the classes C₄, C₈, C₁₄, and C₁₇ of the quantity (four) of the classes of the disk apparatuses D₆ and D₇ that are determined according to the algorithm B are moved, thereby confirming that the relocation of the files executed to change the quantity of disk apparatuses is minimized.

In a fifth example, a case where the quantity of disk apparatuses D₁ to Dₙ is changed from five (b=5) to three (a=3) in the storage system 100 depicted in FIG. 1 will be taken as an example and described. Illustration and description of parts identical to those described in the first example will be omitted.

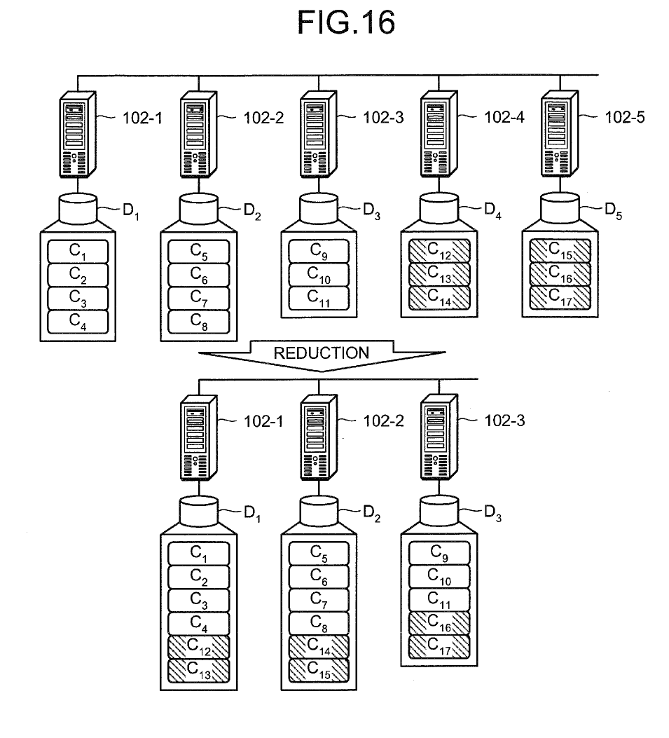

FIG. 16 is a schematic of distributed storage processing in the fifth example of the second embodiment.

As depicted in FIG. 16, the classes C₁ to C₁₇ are allocated to the disk apparatuses D₁ to D₅ that are respectively included in the servers 102-1 to 102-5. More specifically, according to the above algorithm “A”, four classes are allocated to each of the disk apparatuses D₁ and D₂ and three classes are allocated to each of the disk apparatuses D₃ to D₅.

The quantity of disk apparatuses D₁ to D₅ is changed from five, which is the current quantity, to three. In this case, the disk apparatuses D₄ and D₅ each having the largest disk numbers among the five disk apparatuses D₁ to D₅ are subject to the reduction. According to the above algorithm C, the quantity of classes to be allocated to each of the disk apparatuses D₁ to D₃ after the change is determined.

In this case, the quantity of classes of each of the disk apparatuses D₁ and D₂ is six and the quantity of classes of the disk apparatus D₃ is five. The classes C₁₂ to C₁₇ allocated to the disk apparatuses D₄ and D₅ are selected as the classes to be relocated. The classes to be relocated are allocated to the disk apparatuses D₁ to D₃.

In this case, the class allocating unit 303 allocates the classes to be relocated sequentially in ascending order of class number to the disk apparatuses D₁ to D₃ each having a relatively small disk number. More specifically, C₁₂ and C₁₃ allocated to the disk apparatus D₄ are allocated to the disk apparatus D₁. C₁₄ allocated to the disk apparatus D₄ and C₁₅ allocated to the disk apparatus D₅ are allocate to the disk apparatus D₂. C₁₆ and C₁₇ allocated to the disk apparatus D₅ are allocated to the disk apparatus D₃.

Using an arbitrary approach and based on the allocation by the class allocating unit 303, the files belonging to the classes C₁₂ to C₁₇ are transferred to the disk apparatuses D₁ to D₃ by class. As a result, the files are stored in the disk apparatuses D₁ to D₃. For example, as the result of the allocation of the class C₁₂ to the disk apparatus D₁, the files belonging to the class C₁₂ are transferred from the disk apparatus D₄ to the disk apparatus D₁.

Distributed storage processing in the fifth example of the second embodiment will be described. The processing of the pre-operation preparation process is identical to that of the fourth example and description thereof will be omitted.

Distribution storage processing executed when the “b” (five) disk apparatuses D₁ to D₅ currently in-use are reduced to “a” (three) disk apparatuses D₁ to D₃ will be described. The quotient obtained by dividing the quantity M of classes by the quantity of disk apparatuses D₁ to D₃ “a” (a=3) after the reduction is denoted by “q₂” and the remainder obtained thereby is denoted by “r₂”.

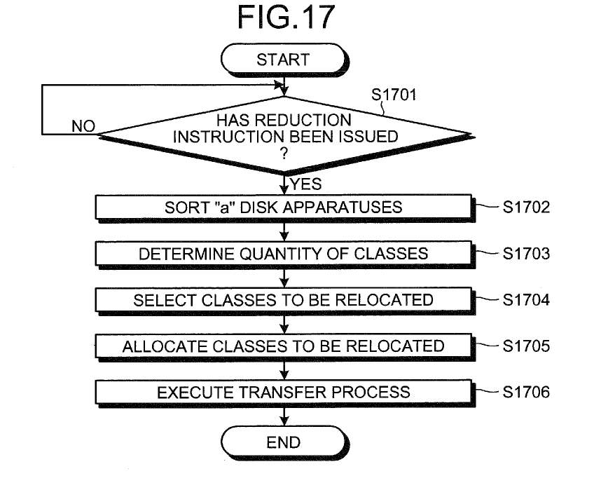

FIG. 17 is a flowchart of distributed storage processing for the reduction. As depicted in the flowchart of FIG. 17, whether input of a reduction instruction instructing a reduction in the quantity of disk apparatus to be used has been received is determined (step S1701).

Reception of the reduction instruction is waited for (step S1701: NO). When the reduction instruction to change the quantity from “b” (b=5) to “a” (a=3) is received (step S1701: YES), the class allocating unit 303 sorts the “a” disk apparatuses D₁ to D₃ after the reduction such that the quantities of classes allocated to the apparatuses before the reduction are in descending order (step S1702).

The class allocating unit 303 determines the quantity of classes to be allocated to the r₂ (two) disk apparatuses D₁ and D₂ from the head of the sorted “a” disk apparatuses D₁ to D₃, as (q₂+1) (six) and the quantity of classes to be allocated to the remaining disk apparatuses D₃, as q₂ (five) (step S1703).

Thereafter, the class allocating unit 303 selects the classes C₁₂ to C₁₇ allocated to the disk apparatuses D₄ and D₅ targeted in the reduction as the classes to be relocated (step S1704). The class allocating unit 303 allocates the selected classes C₁₂ to C₁₇ to the disk apparatuses D₁ to D₃ only in the quantity of classes determined at step S1703 (step S1705).

A transfer process of transferring the files belonging to the classes C₁₂ to C₁₇ to the disk apparatuses D₁ to D₃ by class is executed based on the allocation (allocation table) by the class allocating unit 303 at step S1705 (step S1706) and a series of the processing according to the flowchart comes to an end.

According to the fifth example, the relocation of the files executed when the quantity of disk apparatuses D₁ to Dₙ is changed from “b” (b=5) to “a” (b=3) can be minimized. More specifically, the relocation of the files can be minimized as a result of determining the quantity of classes according to the algorithm C and selecting the classes to be relocated such that the relocation of the classes is minimized.

In the example depicted in FIG. 15, only the classes C₁₂ to C₁₇ of the quantity (six) of the classes of the disk apparatuses D₄ and D₅ targeted in the reduction are moved, thereby confirming that the relocation of the files executed to change the quantity of disk apparatuses is minimized.

The distributed storage managing apparatus 101 according to the third example will be described. A specific fixed value is determined before the start of the operation as the quantity M of classes in the first and the second embodiments. However, in the third embodiment, an approach of dynamically varying the quantity M of classes according to the quantity of storage apparatuses actually used is proposed.

In a case where the quantity M of classes is a fixed value as in the first and the second embodiments, when the quantity M of classes is determined to be a small value, the equality of the load distribution is lost as the quantity of storage apparatuses increases. On the other hand, when the quantity of classes is determined to be a large value, the overhead such as an increase of the volume of data of the allocation table and an increase in the allocation processing load becomes significant.

In the third embodiment, the quantity M of classes is made small when the quantity of storage apparatuses is small and the quantity of classes M is made large when the quantity of storage apparatuses is large; thus, relocation of files when the quantity of storage apparatuses is changed is minimized similarly to the first and the second embodiments and the above trade-off is prevented.

Detailed processing of the control unit (the obtaining unit 301 to the transmitting unit 305) of the distributed storage managing apparatus 101 according to the third embodiment will be described. Components identical to those described in the first and the second embodiments will be given the same respective reference numerals and description thereof will be omitted.

The obtaining unit 301 obtains quantities of classes {M1, M2 . . . , Mn} of the classes to be allocated with an arbitrary group of files and a coefficient X (that corresponds to an “equality coefficient X” in examples described hereinafter) that represents the equality among the quantities of classes allocated to the storage apparatuses.

The quantities of classes {M1, M2, . . . , Mn} constitute an arbitrary digit string that satisfies that “M (i+1) is a multiple of Mi (where i=1, 2, . . . , n)”. More specifically, for example, fixed values such as {256 (=2⁸), 65536 (=2¹⁶), 1677216 (=2²⁴)} may be used as the quantities of classes.

The coefficient X (a real number equal to one or more) is a value that may be arbitrarily set according to the equality demanded with respect to the quantities of classes to be allocated to the storage apparatuses. The coefficient X that is a real number equal to one or more may be determined using an arbitrary algorithm. Although description follows hereinafter, the equality of the quantities of classes to be allocated to the storage apparatuses may be improved as the coefficient X increases.

For example, the quantities of classes {M1, M2, . . . , Mn} and the coefficient X may be directly input to the distributed storage managing apparatus 101 by a user operation of the input apparatus 220 depicted in FIG. 2 or may obtained from an external apparatus not depicted.

The file allocating unit 302 selects the minimum value Mi that satisfies the following expression (1) from among the quantities of classes {M1, M2, . . . , Mn} obtained by the obtaining unit 301 as the quantity of classes Mi in the initial state. “a” is the quantity of storage apparatuses in the initial state.

a*X<Mi (1)

Expression (1) above means that the value of “a*X” increases and the quantity of classes Mi selected increases as the coefficient X increases and as a result, equality among the quantities of classes to be allocated to the storage apparatuses is improved. On the other hand, expression (1) also means that the value of “a*X” decreases and the quantity of classes Mi selected decreases as the coefficient X decreases and as a result, equality among the quantities of classes to be allocated to the storage apparatuses is degraded. When Mi that satisfies expression (1) is not present among the quantities of classes {M1, M2, . . . , Mn}, the maximum quantity Mn of the quantities of classes may be selected.

The file allocating unit 302 allocates the arbitrary files to the classes of the quantity Mi selected from the quantities of classes {M1, M2, . . . , Mn} according to a predetermined algorithm. In this case, the predetermined algorithm is an algorithm that satisfies the following conditions (6) and (7). An algorithm that corresponds to the quantity Mi of classes is denoted by “Ci( )”.

(6) The files are sufficiently allocated equally to the classes {C0, C1, . . . , C(Mi−1)} of the quantity Mi.

(7) When two files are allocated to the same class according to C(i+1)( ), the two files are further allocated to the same class according to C(i)( ).

More specifically, for example, Cn( ) may be determined as follows using the maximum value Mn of the quantities of classes. One sufficiently even hash function denoted by h( ) is determined that determines one integer from character strings expressing the file names and the files are classified into Mn classes by congruent (mod Mn) using the Mn as the modulus. Based on the Cn( ), C1 to C(n−1)( ) are determined as follows.

“Ci (file)=the quotient obtained by dividing Cn (file) by Mn/Mi”

Each of the storage apparatuses has a hierarchal structure of classes and each of the files belongs any one of the classes in the lowest hierarchy of the hierarchal structure.

When the quantity of storage apparatus in-use is changed from “a” to “b” (where a<b), the file allocating unit 302 selects the minimum value Mi that satisfies expression (2) from among the quantities of classes {M1, M2, . . . , Mn} as a new quantity of classes Mi. When Mi that satisfies expression (2) is not present among the quantities of classes {M1, M2, . . . , Mn}, the maximum quantity Mn of the quantities of classes may be selected.

b*X<Mi (2)

In this case, the file allocating unit 302 allocates the files to the classes of the new quantity Mi of classes using an algorithm that satisfies the conditions (6) and (7). Here, the process load for the allocation of the files can be reduced by satisfying the above condition (7).

When the quantity of storage apparatuses in-use is changed from “b” to “a” (where a<b), the file allocating unit 302 may also select the minimum value Mi that satisfies “a*X<Mi” from among the quantities of classes {M1, M2, . . . , Mn} as the new quantity Mi of classes. In this case, similarly to that above, the file allocating unit allocates the files to the classes of the new quantity Mi of classes.

Details of the processing by the class allocating unit 303, the generating unit 304, and the transmitting unit 305 is identical to that described in the second embodiment and, therefore, description thereof is omitted.

According to the third embodiment, the quantity M of classes can be dynamically changed according to the quantity of storage apparatuses used. Thus, the trade-off associated with the magnitude of the quantity of classes can be avoided and the relocation of the files executed when the quantity of storage apparatuses is changed can be minimized.

In a sixth example, a case where the quantity of disk apparatuses D₁ to Dₙ is changed from 20 (a=20) to 30 (b=30) in the storage system 100 will be taken as an example and described.

The equality coefficient X that represents the equality among the quantities of classes is determined as the pre-operation preparation. In this case, “10” is determined as the equality coefficient X. As a result, the obtaining unit 301 obtains the equality coefficient X (X=10).

The quantities of classes {M1, M2, . . . , Mn} of the classes to be allocated with an arbitrary group of files are selected. In this case, {256, 65536, 1677216} are selected as the quantities of classes. As a result, the obtaining unit 301 obtains the quantities of classes {256, 65536, 1677216}.

The file allocating unit 302 determines an algorithm Ci( ) that corresponds to the quantity Mi of classes according to the conditions (6) and (7). In this case, the following algorithms are determined as algorithms C( ), C2( ), and C3( ) that respectively correspond to the quantities of classes {256, 65536, 1677216}.

C1 (file)=the value of the highest byte of SHAL (file name)

C2 (file)=the value of the second highest byte of SHA1 (file name)

C3 (file)=the value of the third highest byte of SHA1 (file name)

The quantity “a” of disk apparatuses D₁ to Dₙ in the initial state is determined. In this case, 20 (a=20) of the disk apparatuses D₁ to D₂₀ is determined as the quantity of disk apparatuses in the initial state. Thereafter, the file allocating unit 302 selects the minimum value Mi that satisfies expression (1) from among the quantities of classes {256, 65536, 1677216} as the quantity Mi of classes in the initial state. In this case, the quantity M1 of classes (=256) that satisfies “a*X=200<Mi” is selected.

The classes of the quantity M1, that is, 256 classes C₁ to C₂₅₆ are defined and the file allocating unit 302 sufficiently allocates the arbitrary files equally to the classes C₁ to C₂₅₆. The class allocating unit 303 determines the quantity of classes to be allocated to the disk apparatuses D₁ to D₂₀ according to the algorithm A described in the second embodiment.

The quantity of classes to be allocated to each of the disk apparatuses D₁ to D₁₇ is 13 and the quantity of classes to be allocated to each of the disk apparatuses D₁₈ to D₂₀ is 12. The class allocating unit 303 allocates classes of only the quantity of classes C₁ to C₂₅₆ determined for the disk apparatuses D₁ to D₂₀. In this case, the classes are allocated in ascending order of class number to the disk apparatuses in ascending order of disk number.

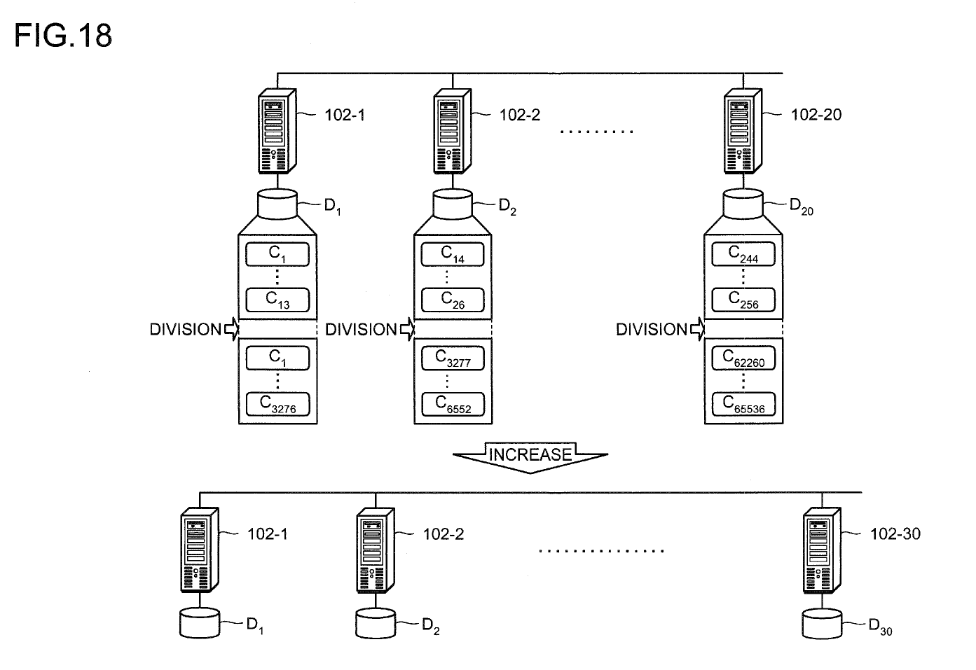

FIG. 18 is a schematic of an overview of distributed storage processing in the sixth example of the third embodiment.

As depicted in FIG. 18, the classes C₁ to C₂₅₆ are allocated equally to the disk apparatuses D₁ to D₂₀ respectively included in the servers 102-1 to 102-20. The quantity of disk apparatuses D₁ to D₂₀ is changed from 20, which is the current quantity, to 30. In this case, disk apparatuses D₂₁ to D₃₀ respectively included in servers 102-1 to 102-30 are added.

The new quantity Mi of classes is selected from among the quantities of classes {256, 65536, 1677216} using expression (2). In this case, the quantity M2 of classes (=65536) that satisfies “b*X=300<Mi” is selected. Thereafter, the class allocating unit 303 determines whether the quantity Mi of classes has changed in association with the change in the quantity of the disk apparatus used D₁ to D₂₀. In this case, the quantity Mi of classes has changed from the quantity of classes M1 to the quantity of classes M2.

In this case, the existing classes C₁ to C₂₅₆ are divided according to a new classification manner. In this division, the allocation table that indicates corresponding relations between the classes and the disk apparatuses D₁ to D₂₀ is replaced according to the new classification manner. More specifically, the size of the allocation table is changed from that having 256 lines to that having 65536 lines. The disk apparatuses D₁ to D₂₀ that are correlated with C0 before the variation are correlated with C0 to C255. Similarly, the disk apparatuses D₁ to D₂₀ that are correlated with C1 to C255 before the variation are correlated with “C256 to C511” to “C65024 to C65535”.

The algorithm that determines the allocation destinations of the files is replaced by a new algorithm.

The algorithm that determines the allocation destinations of the files is changed from C1( ) to C2( ). In the class hierarchal structure that each of the disk apparatuses D₁ to D₂₀ has, the classification is to be executed using the classification that is currently executed using a first hierarchy as a classification that uses a second hierarchy.

The class allocating unit 303 determines the quantity of classes to be allocated to each of the disk apparatuses D₁ to D₃₀ after the change according to the algorithm B described in the second embodiment. The quantity of classes of each of the disk apparatuses D₁ to D₁₆ is 2,185 and the quantity of classes of each of the disk apparatuses D₁₇ to D₃₀ is 2,184.

The class allocating unit 303 selects the classes to be relocated from among the classes allocated to the disk apparatuses D₁ to D₂₀ whose quantities of classes are to be decreased and the class allocating unit 303 allocates to the disk apparatuses D₂₁ to D₃₀, the classes to be relocated. Details of the processing by the class allocating unit 303 is identical to that described in the second embodiment and, therefore, illustration and description thereof will be omitted.

Details of a pre-operation preparation process will be described. The disk apparatuses D₁ to Dₙ in the initial state are 20 (a=20) apparatuses that are the disk apparatuses D₁ to D₂₀.

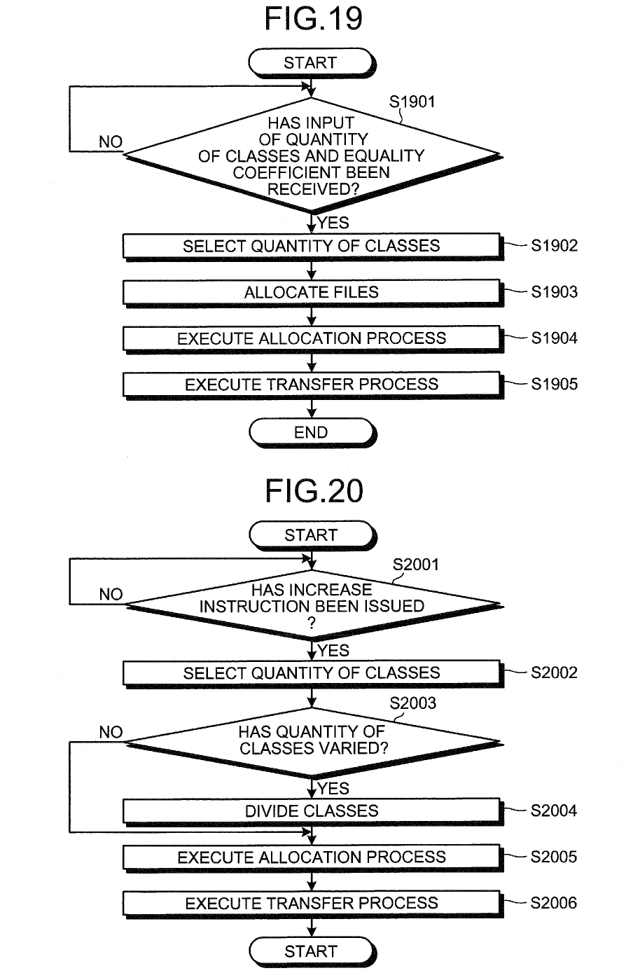

FIG. 19 is another flowchart of the pre-operation preparation process. As depicted in the flowchart of FIG. 19, whether input of the quantities of classes {256, 65536, 1677216} and the equality coefficient X (X=10) has been received is determined (step S1901).

Input of the quantities of classes {256, 65536, 1677216} and the equality coefficient X is waited for (step S1901: NO). When the input is received (step S1901: YES) the file allocating unit 302 selects the quantity Mi of classes (=M1=256) in the initial state from among the quantities of classes {256, 65536, 1677216} using expression (1) (step S1902).

Thereafter, the file allocating unit 302 sufficiently allocates equally the files retained by the storage system 100 to the classes of the quantity Mi obtained at step S1902, that is, the 256 classes C₁ to C₂₅₆ (step S1903)

The class allocating unit 303 executes an allocation process of allocating to the disk apparatuses D₁ to D₂₀, the classes C₁ to C₂₅₆ to which the files are allocated to by the file allocating unit 302 (step S1904).

A transfer process of transferring the files to the disk apparatuses D₁ to D₂₀ by class is executed based on the allocation (allocation table) by the class allocating unit 303 at step S1904 (step S1905) and a series of the processing according to the flowchart comes to an end.

Distributed storage processing executed when the 20 disk apparatuses D₁ to D₂₀ currently in-use are increased to 30 disk apparatuses D₁ to D₃₀ will be described.

FIG. 20 is another flowchart of the distributed storage processing for an increase. As depicted in the flowchart of FIG. 20, whether input of an increase instruction instructing an increase in the quantity of disk apparatuses to be used has been received is determined (step S2001).

Reception of the increase instruction is waited for (step S2001: NO). When the increase instruction to change the quantity of disk apparatuses from “a” (a=20) to “b” (b=30) is received (step S2001: YES), the file allocating unit 302 selects a new quantity M1 of classes (=M2=65536) from among the quantities of classes {256, 65536, 1677216} using the expression (2) (step S2002).

Whether the quantity Mi of classes selected at step S2002 has changed is determined (step S2003). When the quantity of classes Mi has changed (step S2003: YES), the file allocating unit 302 divides the existing classes C₁ to C₂₅₆ according to a new classification manner (step S2004).

The class allocating unit 303 executes an allocation process of allocating the classes C₁ to C₆₅₅₃₆ divided by the file allocating unit 302 to the disk apparatuses D₁ to D₃₀ after the change (step S2005).

A transfer process of transferring the files to the disk apparatuses D₁ to D₃₀ by class based on the allocation (allocation table) by the class allocating unit 303 at step S2005 is executed (step S2006) and a series of the processing according to the flowchart comes to an end.

When the quantity Mi of classes selected has not changed at step S2003 (step S2003: NO), the processing advances to step S2005 where the class allocating unit 303 allocates to the disk apparatuses D₁ to D₃₀ that are to be used after the change, the classes C₁ to C₂₅₆ to which the files are allocated.

According to the sixth example, the quantity M of classes allocated with the files can be dynamically changed (256 to 65536) together with the change in the quantity of disk apparatuses D₁ to Dₙ (from 20 to 30). Thereby, the equality of the load distribution in changing the quantity of disk apparatuses D₁ to Dₙ can be properly maintained.

As described, according to the first, the second, and the third embodiments, the relocation of files executed when the quantity of disk apparatuses is changed can be minimized thereby, enabling the performance of the storage system to be improved.

The distributed storage managing method explained in the first to the third embodiments can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing therein a distributed storage managing program that causes a computer to execute:
obtaining a common multiple M of quantities of storage apparatuses to be re-organized;
allocating, according to a predetermined algorithm, files stored in the storage apparatuses to classes of a quantity that is the common multiple M obtained at the obtaining; and
allocating to storage apparatuses of a quantity that is different from a current quantity of storage apparatuses, the files allocated at the allocating of the files, when the current quantity of storage apparatuses is changed to the quantity that is different from the current quantity, the allocating further being by class and based on an allocation table indicating corresponding relations between the classes and the storage apparatuses to which the classes are allocated.

2. A computer-readable recording medium storing therein a distributed storage managing program that causes a computer to execute:
obtaining a quantity M, the quantity M being a quantity of classes to which files are to be allocated;
allocating, according to a predetermined algorithm, the files to the classes of the quantity M obtained at the obtaining; and
allocating, by class and to storage apparatuses of a second quantity that is different from a current quantity of storage apparatuses, the files allocated to the classes of the quantity M at the allocating of the files to the classes, when a quantity of storage apparatuses used to store the files is changed from the current quantity to the second quantity.

3. The computer-readable recording medium according to claim 2, wherein
the allocating of the files by class includes allocating based on an allocation table indicating corresponding relations between the classes and the storage apparatuses currently used when the files are stored in the current quantity of storage apparatuses.

4. The computer-readable recording medium according to claim 2, wherein
the obtaining includes obtaining a common multiple M of a plurality of quantities of storage apparatuses to be re-organized,
the allocating of the files to the classes includes allocating, according to a predetermined algorithm, the files to classes of a quantity equivalent to the common multiple M obtained at the obtaining, and
the allocating of the files by class includes allocating (M/a−M/b) classes among M/a classes allocated to the “a” storage apparatuses to each of (b−a) storage apparatuses to be re-organized, when the quantity of storage apparatuses used is changed from “a” to “b”, “a” being less than “b”.

5. The computer-readable recording medium according to claim 4, wherein
the allocating of the files by class includes allocating (M'(1−a/b)) classes allocated to the (b−a) storage apparatuses to be re-organized to “a” storage apparatuses, each being allocated (M/a−M/b) classes, when the quantity of storage apparatuses used is changed from “a” to “b”, “a” being less than “b”.

6. The computer-readable recording medium according to claim 2, the distributed storage managing program further causing the computer to execute:
generating an allocation table indicating corresponding relations between the classes and the storage apparatuses to which the classes are allocated, based on a class allocation resulting at the allocating of the files by class; and
transmitting the allocation table generated at the generating to information processing apparatuses that control reading and writing of files with respect to the storage apparatuses.

7. The computer-readable recording medium according to claim 6, wherein
generating includes generating an allocation table indicating corresponding relations between the classes and the storage apparatuses to which the classes are allocated, for each quantity of storage apparatuses of a plurality of quantities of storage apparatuses to be re-organized.

8. The computer-readable recording medium according to claim 2, wherein
the allocating of the files by class includes sorting “b” storage apparatuses such that the quantities of classes allocated to the “b” storage apparatuses are in descending order, allocating (q+1) classes to each of “r” storage apparatuses from a head of the sorted “b” storage apparatuses, and allocating “q” classes to each of the remaining storage apparatuses, when the quantity of storage apparatuses used is changed from “a” to “b” and a current quantity of classes allocated to (b−a) storage apparatuses to be re-organized is zero, “a” being less than “b”, “q” being the quotient obtained by dividing M by “a”, and “r” being the remainder obtained by the dividing M by “a”.

9. The computer-readable recording medium according to claim 8, wherein
the allocating of the files by class further includes sorting the “a” storage apparatuses such that the quantities of classes allocated to the “a” storage apparatuses are in descending order, allocating (q+1) classes to each of the “r” storage apparatuses from the head of the sorted “a” storage apparatuses, and allocating “q” classes to each of the remaining storage apparatuses, when the quantity of storage apparatuses used is changed from “b” to “a” “a” being less than “b” “q” being the quotient obtained by dividing M by “a”, and “r” being the remainder obtained by the dividing M by “a”.

10. The computer-readable recording medium according to claim 8, the distributed storage managing program further causing the computer to execute:
generating an allocation table indicating corresponding relations between the classes and the storage apparatuses to which the classes are allocated, based on a class allocation resulting at the allocating of the files by class; and
transmitting the allocation table generated at the generating to information processing apparatuses that control reading and writing of files with respect to the storage apparatuses.

11. The computer-readable recording medium according to claim 8, wherein
the obtaining includes obtaining a plurality of quantities of classes {M1, M2, . . . , Mn} to which the files are to be allocated, and
the allocating of the files to the classes includes allocating the files to classes of the quantity M selected from among the quantities of classes {M1, M2, . . . , Mn} obtained at the obtaining and according to the quantity of storage apparatuses used to store the files.

12. The computer-readable recording medium according to claim 11, wherein
the obtaining includes obtaining the quantities of classes {M1, M2, . . . , Mn} constituting an arbitrary digit string where M(i+1) is a multiple of Mi and i=1, 2, . . . , n−1, and
the allocating of the files to the classes includes selecting, from among the quantities of classes {M1, M2, . . . , Mn}, a minimum quantity of classes M that is larger than a value obtained by multiplying a coefficient X that represents equality among the quantities of classes allocated to the storage apparatuses and the quantity of storage apparatuses used to store the files.

13. A distributed storage managing apparatus comprising:
an obtaining unit that obtains a quantity M, the quantity M being a quantity of classes to which files are to be allocated;
a file allocating unit that, according to a predetermined algorithm, allocates the files to the classes of the quantity M obtained by the obtaining unit; and
a class allocating unit that allocates, by class and to storage apparatuses of a second quantity that is different from a current quantity of storage apparatuses, the files allocated to the classes of the quantity M by the file allocating unit, when a quantity of storage apparatuses used to store the files is changed from the current quantity to the second quantity.
